(19) United States
(12) Patent Application Publication
(10) Pub. No.: US 2007/0116861 A1
(43) Pub. Date: May 24, 2007

(54) Method and apparatus of forming pattern of display panel

(76) Inventors: Teruo Maruyama, Hirakata-shi (JP); Nobutaka Hokazono, Neyagawa-shi (JP); Takayuki Furukawa, Ikoma-shi (JP); Koji Matsuo, Kobe-shi (JP); Takashi Kanehisa, Osaka-shi (JP); Takafumi Okubo, Hirakata-shi (JP); Takahiro Yoshida, Takatsuki-shi (JP)

Correspondence Address: WENDEROTH, LIND & PONACK L.L.P., 2033 K. STREET, NW, SUITE 800, WASHINGTON, DC, 20006, US

(21) Appl. No.: 11/653,894

(22) Filed: Jan. 17, 2007

Related U.S. Application Data
(62) Division of application No. 10/322,490, filed on Dec. 19, 2002.

(30) Foreign Application Priority Data
Dec. 19, 2001 (JP) 2001-385804

(51) Int. Cl. B05D 5/12; B05D 5/06; B05B 3/00; B05C 11/00

(52) U.S. Cl. 427/64; 427/68; 118/323; 118/680

(57) ABSTRACT

In manufacturing a display panel of a PDP, a CRT, or the like, for example, a screen stripe is formed on a panel surface in a production cycle time equivalent to or faster than that of a screen printing system. By using a dispenser of a variable flow rate type for a display panel that has an effective display area in which a paste layer is to be formed and a non-effective display area in which no paste layer is to be formed, outside this effective display area, paste discharge is promptly interrupted when a discharge nozzle runs through the non-effective display area of the display panel.

### BACKGROUND OF THE INVENTION

The present invention relates to the technical field of manufacturing display panels such as a PDP (Plasma Display Panel), an LCD, an organic EL (Electro-Luminescence), a CRT (Cathode Ray Tube), and so on.

Prior art issues will be described below taking formation of a screen stripe of a fluorescent material, an electrode material, or the like on a display panel as an example.

A case of fluorescent material will be described first.

In a plasma display panel (PDP hereinafter) for performing color display, its faceplate (front surface plate)/backplate (rear surface plate) has fluorescent material layers constructed of fluorescent materials that emit lights in respective R, G, and B colors.

Each of these fluorescent material layers has a structure in which three sets of stripes filled with the fluorescent materials of R, G, and B colors are formed between partition walls formed in a parallel line shape (i.e., on address electrodes) on the faceplate/backplate, and numbers of the three sets of stripes are arranged adjacently parallel to one another. These fluorescent material layers are formed by a screen printing system, a photolithography system, or the like.

In a case of an increased screen size, it has been difficult to accurately adjust a position of the screen printing plate by a conventional screen printing system. In an attempt to charge the fluorescent material, the material has been disadvantageously loaded onto top portions of partition walls, and measures to introduce a grinding process for removing the material or other measures have been required. Moreover, a loading amount of the fluorescent material changes depending on a squeeze pressure, and pressure regulation is extremely delicate and largely depends on a skill level of an operator. Therefore, it is not easy to obtain a constant loading amount over an entire surface of the faceplate/backplate.

It is also possible to form the fluorescent material layer by the photolithography system using a photosensitive fluorescent material. However, there has been an issue that a

manufacturing cost has increased since exposure and development processes have been needed and a number of processes becomes greater than the screen printing system.

A fluorescent screen stripe of a color Braun tube panel is manufactured normally by a photographic development system with an exposure table. According to this system, first, a fluorescent material of one color out of the three primary colors is coated onto an entire surface of the panel.

According to this coating method, there is used, for example, a so-called “shake-off method” for pouring a fluorescent liquid onto an inner surface of the panel and thereafter rotating the panel body to apply a centrifugal force to the fluorescent liquid, thereby causing the fluorescent material to be uniformly coated on the entire surface of the panel.

Next, the panel whose entire surface has been coated with the fluorescent material is integrated with a mask. Only stripe positions of this color fluorescent material are exposed to light on the exposure table and subjected to chemical treatment for development to leave exposed regions, and remaining regions covered with the mask are removed. Next, a photoetching processes of mask exposure and development are similarly repeated for other fluorescent materials of the three primary colors. Accordingly, the photoetching processes are to be repeated three times.

As a method for forming a fluorescent screen stripe, there is otherwise applied an electrostatic coating system. This system, which is theoretically similar to the photographic developing system, differs in that an electrification material is employed as a stripe color fluorescent material and coated by dry coating.

When the fluorescent screen stripe of a Braun tube panel is formed by both the above-mentioned systems, there is needed a large-scale manufacturing apparatus in either system since materials must undergo a number of complicated processes. Therefore, the systems, which have been appropriate for mass production, have had a drawback in that they have had a degraded efficiency for wide-variety and low-volume production.

In order to solve issues about formation of a screen stripe, i.e., the aforementioned issues about the screen printing system of the PDP and the “shake-off method of photographic developing system” of the color Braun tube panel, a direct drawing system (direct patterning) that uses a dispenser has already been proposed.

FIG. 23 shows a fluorescent material layer forming apparatus and formation method intended for a PDP, disclosed in Unexamined Japanese Patent Publication No. 10-27543.

Reference numeral 450 denotes a substrate, 451 denotes a baseplate on which this substrate 450 is placed, 452 denotes a dispenser that discharges a fluorescent material in a paste form, and 453 denotes a discharge nozzle of the dispenser 452.

In order to construct a transport section for moving this discharge nozzle 453 relative to the baseplate 451, a pair of Y-axis direction transport units 454a and 454b is provided on both sides of the baseplate 451. Moreover, an X-axis direction transport unit 455, on which the dispenser 452 is supported, is mounted movably in the Y-axis direction by the Y-axis direction transport units 454a and 454b. Further, a Z-axis direction transport unit 456 is mounted movably in the X-axis direction by the X-axis direction transport unit 455.

According to the above-mentioned proposal, fluorescent material is discharged from the nozzle 453 that is moving over the substrate 450 and coated into grooves between ribs of the substrate 450 only by numerically setting substrate specifications without using a conventional screen mask. Therefore, a fluorescent material layer can be accurately formed on the substrate 450 of an arbitrary size, and this arrangement can easily cope with a change in specifications of the substrate 450.

A similar proposal has already been disclosed in Examined Japanese Patent Publication No. 57-21223 regarding a fluorescent material layer forming apparatus intended for a color Braun tube panel. According to this proposal, there are the advantages of: no need of increasing scales of a manufacturing process and production line; screening enabled by a single unit; manufacturing of Braun tubes of wide-variety and low-volume production achieved with increased mass production effect; and operation of an automated line by a small-scale machine because of screening performed by a single unit.

Even when a fluorescent material screen stripe is formed on a panel surface by a dispenser, a production cycle time equivalent to that of the screen printing system is demanded.

However, there is restriction on the number of dispensers that can be arranged in the coating apparatus, and it is required to sufficiently increase a relative velocity between the panel and the nozzle in order to draw a thousand to several thousands of screen stripes in the shortest possible time.

For the above-mentioned purpose, it is required to reciprocate the dispenser or the transport baseplate on which the panel is placed, with high accuracy and at high speed.

In this case, it is assumed that the panel surface has an “effective display area” (quadrangular area 60a enclosed by the dotted lines in FIG. 2) in which a fluorescent material layer is formed, and a “non-effective display area” (rectangular frame-shaped area 60b outside the rectangular area 60a in FIG. 2) which is arranged outside a peripheral portion of this effective display area and in which no fluorescent material layer is formed.

Moreover, the dispenser is assumed to be placed on the transport baseplate, and attention is paid to behavior of one discharge nozzle. This nozzle, which has run at high speed continuously coating the “effective display area” on the panel surface, reduces its velocity through a deceleration interval when approaching an end surface of the panel and then enters the “non-effective display area”. After making a U-turn in this non-effective display area, the nozzle regularly runs again over the effective display area through an approach-run interval.

That is, a relative velocity between the nozzle and the panel largely changes before and behind the U-turn interval. At this time, the dispenser should preferably have functions as follows.

(1) A flow rate can be changed in accordance with a relative velocity between the nozzle and the panel.

(2) Discharge can be completely interrupted in the U-turn interval (interval of run through the non-effective display area) at end portions of the panel.

(3) After passing through the U-turn interval, “thinning”, “break” and the like do not occur at a start point portion of a coating line at a coating start time. Likewise, “fattening”, “stagnation” and the like do not occur at an end point portion of the coating line at a coating end time.

If the aforementioned item (1) cannot be achieved, then a line width and a thickness of the fluorescent coating line are to exceed prescribed specifications unless the discharge cannot be reduced in spite of, for example, the fact that the relative velocity between the nozzle and the panel becomes smaller than in the case of a regular run.

As production cycle time is increased, it is required to reduce rise and trailing times and increase a rate of change of the relative velocity. That is, the dispenser is required to have a still higher response of flow rate control.

Necessity of the aforementioned item (2) is as follows. When the nozzle runs through the U-turn interval (non-effective display area) at the end portions of the panel, the relative velocity between the nozzle and the panel is zero and enters an extremely low-speed state around zero.

A plurality of stripes overlap one another if material flows out of the nozzle in this interval even at a small flow rate, and therefore, the material is to be accumulated on the panel. As a result, this accumulated material sticks to a tip of the discharge nozzle. When coating was started again in this state, a fluid mass stuck to the tip of the discharge nozzle was discontinuously spattered onto the panel surface, thereby causing a problem such as significant impairment of accuracy of a drawing line. That is, it is preferable that a discharge amount of the dispenser can be completely interrupted in the U-turn interval at the end portions of the panel.

The aforementioned item (3) is an indispensable condition of the dispenser system to secure a quality equivalent to or higher than that of the conventional system of, for example, the screen printing system.

Summarizing the above, in order to form a fluorescent material screen stripe on a panel surface with a high production efficiency using a dispenser, the dispenser preferably has a function capable of arbitrarily performing fluid interruption and release as well as a high response of flow rate control and high flow rate accuracy. However, prior art examples of the dispenser system of, for example, Examined Japanese Patent Publication No. 57-21223 and Unexamined Japanese Patent Publication No. 10-27543 disclose no detailed description of this point.

Dispensers (liquid discharge devices) have conventionally been used in various fields. In accordance with recent needs for downsizing and higher recording density of electronic components, there has been a growing demand for a technology to stably perform supply control of a very small amount of fluid material with high accuracy. Conventionally, a dispenser of an air system as shown in FIG. 24 has widely been used as a liquid discharge device, and technology thereof is introduced in, for example, “Automation Technology, '93, Vol. 25, No. 7” and so on.

The dispenser of this system applies a fixed amount of air supplied from a constant pressure source into a vessel 600 (cylinder) in a pulsative manner, so that a fixed amount of liquid corresponding to an increase in pressure inside the cylinder 601 is discharged from a nozzle 602.

The dispenser of this air system has had the following issues.

(1) Variation in discharge amount due to discharge pressure pulsation.

(2) Variation in discharge amount due to water head difference.

(3) Change in discharge amount due to change in viscosity of liquid.

Issue (1) appears more significantly as cycle time is shorter and discharge time is shorter. Therefore, it is devised to provide a stabilization circuit for making uniform a height of air pulse or in another way.

A reason for issue (2) is that a volume of a space portion inside the cylinder 601 differs depending on a residual liquid quantity H, and therefore a degree of a pressure change inside the space portion is disadvantageously largely changed by the residual liquid quantity H when a prescribed amount of high-pressure air is supplied. There has been an issue that, when the residual liquid quantity H has been reduced, application quantity has disadvantageously been reduced by, for example, about 50 to 60% as compared with a maximum value. Accordingly, there have been taken measures of detecting the residual liquid quantity H at each discharge, and adjusting a time width of a pulse so that a discharge amount becomes uniform, or other measures.

Issue (3) occurs when viscosity of the material that contains, for example, a large amount of solvent changes with a lapse of time. As measures against it, there have been taken measures of preliminarily performing computer programming of a tendency of a change in viscosity with respect to time base and, for example, adjusting a pulse width so as to correct an influence of a change in viscosity, or other measures.

With regard to any of the measures against the aforementioned issues, a control system including a computer has become complicated, and it has been difficult to cope with changes in irregular environmental conditions (temperature and so on), thereby providing no drastic settlement plan.

In addition to the aforementioned issues of the air system, the dispenser of this system has had a drawback of poor response. This drawback is ascribed to compressibility of air enclosed in the cylinder 600 and a nozzle resistance when air is made to pass through a narrow gap. That is, in a case of the air system, a time constant: T=RC of a hydraulic circuit determined by a cylinder volume: C and a nozzle resistance: R is large, and it is required to estimate a time delay of, for example, about 0.07 to 0.1 seconds for start of discharge after an input pulse is applied.

In order to remedy the drawbacks of the air system, there is put into practical use a dispenser, which is provided with a needle valve at an inlet portion of a discharge nozzle and in which an outlet port is opened and closed by moving a small-diameter spool, that constitutes this needle valve, at high speed in an axial direction. However, in this case, a gap between the members that are relativity moving becomes zero when fluid is interrupted, and fine particles having a mean particle diameter of several microns to several tens of microns are destroyed by mechanically receiving a compressive action. Due to various problems occurring as a result, it is often difficult to apply the dispenser to coating of fluorescent material and the like, of an objective of the present invention.

For the above reasons, even if structure of the conventional dispenser or an application method are introduced without modification, it has been difficult to satisfy conditions for forming a fluorescent material screen stripe on a panel surface with a high production efficiency.

Issues of prior art technologies have been described above by taking a case of formation of a screen stripe of fluorescent material on a display panel as an example. Similar issues exist in a case of pattern-forming a material other than the fluorescent material screen stripe, or, for example, an electrode material.

Accordingly, an object of the present invention is to provide a method and apparatus for forming a pattern of a display panel for satisfying conditions for forming a thin film pattern of a fluorescent material, an electrode material, and the like on a display panel surface with high production efficiency by providing a dispenser with functions of high-speed discharge interruption, high-speed discharge release, and flow rate control, the conditions being such that:

(1) a flow rate can be varied with a high response in accordance with acceleration and deceleration of the dispenser; and

(2) high-speed interruption and high-speed release of fluid during shift of a nozzle tip of the dispenser from a coating area to a non-coating area, or vice versa, can be voluntarily performed.

### SUMMARY OF THE INVENTION

In order to achieve the aforementioned object, the present invention is constructed as follows.

A display panel pattern forming method according to the present invention is, approximately, to form a paste layer of a certain pattern by discharging a paste while moving a dispenser of a variable flow rate relatively to a substrate so as to successively discharge the paste in a position, in which discharge of the paste is interrupted when the dispenser is running relatively to an area where the dispenser does not form the pattern on the substrate.

According to a first aspect of the present invention, there is provided a display panel pattern forming method for forming a paste layer of a certain pattern by discharging a paste while moving a dispenser of a variable flow rate relatively to a substrate so as to successively discharge the paste in a position that belongs to the substrate and is to receive discharged paste, the method comprising:

discharging the paste when the dispenser is running relatively to, or across, an effective display area of the substrate, that has the effective display area in which a paste layer is to be formed and a non-effective display area which is located outside the effective display area and in which the paste layer is not to be formed; and interrupting discharge of the paste when the dispenser is running relatively to, or across, the non-effective display area.

According to a second aspect of the present invention, there is provided the display panel pattern forming method as defined in the first aspect, for forming the paste layer of the certain pattern by discharging the paste while moving the dispenser relatively to the substrate on a surface of which a plurality of photoabsorption layers are formed parallel to one another so as to successively discharge the paste in a position that is located between the photoabsorption layers and is to receive discharged paste, wherein discharge of the paste is controlled by using a dispenser of a variable flow rate as the dispenser.

According to a third aspect of the present invention, there is provided the display panel pattern forming method as defined in the second aspect, wherein a discharge amount of the paste is varied by controlling the dispenser in accordance with a relative velocity between the dispenser and the substrate.

According to a fourth aspect of the present invention, there is provided the display panel pattern forming method as defined in the second aspect, wherein the paste is discharged when the dispenser is running relatively to the effective display area of the substrate, that has the effective display area in which the paste layer is to be formed and the non-effective display area which is located outside the effective display area and in which the paste layer is not to be formed; and discharge of the paste is interrupted when the dispenser is running relatively to the non-effective display area.

According to a fifth aspect of the present invention, there is provided the display panel pattern forming method as defined in the second aspect, wherein a thread groove type dispenser is employed as the dispenser, and discharge of the paste is controlled by revolution control of a revolving shaft of the thread groove type dispenser.

According to a sixth aspect of the present invention, there is provided the display panel pattern forming method as defined in the fourth aspect, wherein a thread groove type dispenser is employed as the dispenser, and when the dispenser and the substrate run relatively to the non-effective display area, revolution of the revolving shaft of the thread groove type dispenser is stopped or the revolving shaft is revolved reversely during a run through the effective display area.

According to a seventh aspect of the present invention, there is provided the display panel pattern forming method as defined in the fifth aspect, wherein, when the dispenser and the substrate relatively shift from the effective display area to the non-effective display area, discharge is stopped by reducing and thereafter stopping revolution of the revolving shaft of the thread groove type dispenser, or discharge is stopped by stopping after being reduced and then reversing revolution of the revolving shaft.

According to an eighth aspect of the present invention, there is provided the display panel pattern forming method as defined in the fifth aspect, wherein, when the dispenser and the substrate relatively shift from the non-effective display area to the effective display area, discharge is effected by increasing a revolution number of the revolving shaft of the thread groove type dispenser and thereafter maintaining constant the revolution of the revolving shaft, or discharge is effected by increasing and thereafter reducing a revolution number and thereafter maintaining constant the revolution of the revolving shaft.

According to a ninth aspect of the present invention, there is provided the display panel pattern forming method as defined in the fifth aspect, wherein a plurality of thread groove type dispensers are employed as the dispenser, and prescribed flow rates are set by individually adjusting revolution numbers of the plurality of thread groove type dispensers.

According to a tenth aspect of the present invention, there is provided the display panel pattern forming method as defined in the second aspect, wherein the dispenser supplies the paste to a fluid transport chamber that serves as a paste pressure-feed device and is formed of a cylinder and a piston and varies a discharge amount of the paste by increasing and decreasing a space of the fluid transport chamber with a relative axial motion given to the cylinder and the piston.

According to an eleventh aspect of the present invention, there is provided the display panel pattern forming method as defined in the tenth aspect, wherein the paste is pressure-fed by giving a relative rotary motion to a thread groove formed on a relative displacement surface of the cylinder and the piston.

According to a twelfth aspect of the present invention, there is provided the display panel pattern forming method as defined in the tenth aspect, wherein, when a tip of the nozzle and the substrate relatively shift from the effective display area to the non-effective display area, discharge of the paste is stopped by increasing the space of the fluid transport chamber.

According to a thirteenth aspect of the present invention, there is provided the display panel pattern forming method as defined in the tenth aspect, wherein, when a tip of the nozzle and the substrate relatively shift from the non-effective display area to the effective display area, the paste is discharged by reducing the space of the fluid transport chamber formed of the cylinder and the piston.

According to a fourteenth aspect of the present invention, there is provided the display panel pattern forming method as defined in the tenth aspect, wherein, when a tip of the nozzle and the substrate run relatively to the non-effective display area, discharge of the paste continues being stopped by increasing the space of the fluid transport chamber formed of the cylinder and the piston.

According to a fifteenth aspect of the present invention, there is provided the display panel pattern forming method as defined in the second aspect, wherein the dispenser pressure-feeds the paste to a fluid transport chamber that serves as a paste pressure-feed device and is formed of a cylinder, a piston, and a sleeve that accommodates at least part of this piston and varies discharge of the paste by increasing and decreasing a space of the fluid transport chamber with a relative axial motion given to the cylinder and the piston, and to the piston and the sleeve.

According to a sixteenth aspect of the present invention, there is provided the display panel pattern forming method as defined in the fifteenth aspect, wherein discharge of the paste is started or stopped by making a displacement curve of the cylinder relative to the piston, and a displacement curve of the piston relative to the cylinder, have an approximately opposed phase or a reversed movement direction.

According to a seventeenth aspect of the present invention, there is provided the display panel pattern forming method as defined in the second aspect, wherein the variable flow rate dispenser performs discharge flow rate control of the paste by increasing and decreasing a fluid resistance of the paste with a gap of a passage between the shaft and a housing changed by driving the shaft relatively to the housing in an axial direction.

According to an eighteenth aspect of the present invention, there is provided the display panel pattern forming method as defined in the seventeenth aspect, wherein the dispenser discharges the paste by generating a pumping pressure for pressure-feeding the paste from an inlet port to an outlet port of the housing with the shaft revolved relatively to the housing.

According to a nineteenth aspect of the present invention, there is provided the display panel pattern forming method as defined in the seventeenth aspect, wherein outflow of the paste is interrupted by a dynamic pressure seal formed on a relative displacement surface of the shaft and the housing.

According to a twentieth aspect of the present invention, there is provided the display panel pattern forming method as defined in the nineteenth aspect, wherein the dispenser performs flow rate control of the paste by increasing and decreasing a fluid resistance of the paste with a gap of the passage, where the dynamic pressure seal is formed between the shaft and the housing, changed by revolving the shaft relatively to the housing and moving the shaft relatively to the housing in the axial direction.

According to a twenty-first aspect of the present invention, there is provided a display panel pattern forming apparatus for forming a paste layer of a certain pattern by discharging a paste between a plurality of photoabsorption layers provided parallel to one another on a surface of a substrate, the apparatus comprising:

a baseplate for placing the substrate thereon;

a dispenser having at least one nozzle for discharging the paste;

a transport unit for moving the nozzle relatively to the baseplate; and

a control unit for controlling the transport unit and the dispenser so that the paste is successively discharged in prescribed positions between the photoabsorption layers,

with the dispenser being a thread groove type dispenser.

According to a twenty-second aspect of the present invention, there is provided the display panel pattern forming apparatus as defined in the twenty-first aspect, wherein

the dispenser comprises:

a cylinder which has an inlet port and an outlet port for the paste, and in which a fluid transport chamber is formed;

a piston accommodated in the cylinder; and

an actuator for providing relative motion between the cylinder and the piston in order to increase and decrease an internal space formed of the cylinder and the piston,

with the apparatus being constructed so that the paste, which has flowed into the fluid transport chamber from the inlet port, flows out via a passage connected to the internal space to the outlet port.

According to a twenty-third aspect of the present invention, there is provided the display panel pattern forming apparatus as defined in the twenty-first aspect, wherein

in place of the thread groove type dispenser, the dispenser comprises:

a first actuator;

a piston for being driven in a rectilinear direction by the first actuator;

a housing that houses the piston and has an inlet port and an outlet port for the paste;

a cylinder arranged coaxially with the piston; and

a second actuator for producing a relative rotary motion between the piston and the cylinder,

with the apparatus being constructed so that a pump chamber for communicating with the inlet port and the outlet port is formed between the piston and the housing, a pumping action is given to the pump chamber by a rotary motion or a rectilinear motion of the piston relative to the cylinder by driving the first actuator or the second actuator, and the first actuator is moved or extended and retracted by being externally supplied with electric power electromagnetically in a non-contact manner so as to move the piston by the first actuator.

According to a twenty-fourth aspect of the present invention, there is provided the display panel pattern forming apparatus as defined in the twenty-first aspect, wherein

in place of the thread groove type dispenser, the dispenser comprises:

a shaft;

a housing that houses the shaft and has an inlet port and an outlet port for the paste, these ports allowing a pump chamber formed between the housing and the shaft to communicate with an exterior;

a unit for revolving the shaft relative to the housing;

an axial drive unit for providing axial relative displacement between the shaft and the housing; and

a unit for pressure-feeding the paste, which has flowed into the pump chamber, to an outlet port side,

with the apparatus being constructed so that a gap between the shaft and the housing is changed by the axial drive unit in order to increase and decrease a fluid resistance of the paste between the pump chamber and the outlet port.

According to a twenty-fifth aspect of the present invention, there is provided the display panel pattern forming apparatus as defined in the twenty-first aspect, wherein

the dispenser comprises:

a piston;

a housing that houses the piston and has an inlet port and an outlet port for the paste;

a first actuator that moves the piston relatively to the housing;

a cylinder having a space that accommodates at least a part of the piston and penetrates in an axial direction; and

a second actuator that moves the cylinder relatively to the housing,

with the paste being supplied externally from the inlet port into a pump chamber formed of the piston, the cylinder, and the housing, and discharged from the outlet port.

According to a twenty-sixth aspect of the present invention, there is provided a display panel pattern forming apparatus, wherein

the dispenser comprises:

a piston accommodated in a cylinder;

an actuator that provides for relative motion between the cylinder and the piston in order to increase and decrease an internal space formed of the cylinder and the piston;

a housing that houses the cylinder, or is integrated with the cylinder, and has an inlet port and an outlet port for the paste; and

a fluid transport chamber formed in the housing,

with the apparatus being constructed so that the paste, which has flowed into the fluid transport chamber from the inlet port, flows out via a passage connected to the internal space to the outlet port.

According to a twenty-seventh aspect of the present invention, there is provided the display panel pattern forming apparatus as defined in the twenty-sixth aspect, which employs a dispenser in which a gap between the piston and its opposite surface is formed to be greater than a particle diameter of a particle included in material to be discharged when paste discharge is interrupted.

According to a twenty-eighth aspect of the present invention, there is provided the display panel pattern forming apparatus as defined in the twenty-seventh aspect, wherein a minimum gap when paste discharge is interrupted is not smaller than 8 μm in a passage extended from the inlet port to the discharge nozzle.

According to a twenty-ninth aspect of the present invention, there is provided the display panel pattern forming apparatus as defined in the twenty-first aspect, wherein the control unit controls so that the paste is discharged when the dispenser is running relatively to an effective display area of the substrate, that has the effective display area in which the paste layer is to be formed and a non-effective display area which is located outside the effective display area and in which the paste layer is not to be formed, and discharge of the paste is interrupted when the dispenser is running relatively to the non-effective display area.

According to a thirtieth aspect of the present invention, there is provided the display panel pattern forming method as defined in the first aspect, wherein the paste is discharged when the dispenser is running relatively to an effective display area and a semi-effective display area of the substrate, that has the effective display area in which an electrode layer is to be formed as the paste layer, the semi-effective display areas which are arranged adjacent to the effective display area and in which a continuous electrode layer and a discontinuous electrode layer are to be formed, and a non-effective display area which is provided virtually outside the effective display area and the semi-effective display areas and in which no electrode layer is to be formed, and discharge of the paste is interrupted when the dispenser is running relatively to the non-effective display area.

According to a thirty-first aspect of the present invention, there is provided the display panel pattern forming method as defined in the second aspect, wherein discharge of the paste is started in the semi-effective display area or discharge in the effective display area is interrupted inside the semi-effective display area.

According to a thirty-second aspect of the present invention, there is provided the display panel pattern forming method as defined in the third aspect, wherein the paste starts being discharged in a shape of a plurality of stripes in the semi-effective display area located adjacent to the effective display area by a dispenser that has a plurality of nozzles arranged at a regular pitch, and thereafter discharge of the paste is performed via the effective display area, and discharge of the paste in the shape of the plurality of stripes is interrupted in the semi-effective display area located adjacent to another side of the effective display area.

According to a thirty-third aspect of the present invention, there is provided the display panel pattern forming method as defined in the second aspect, wherein only electrode layers in shape of a plurality of angled stripes having same angle of inclination are selected from the paste layer in the semi-effective display area by a dispenser that has a plurality of nozzles arranged at a regular pitch, and

the electrode layers in the shape of the plurality of stripes are formed by concurrently performing discharge in the shape of the plurality of stripes in the semi-effective display area and/or the effective display area.

According to a thirty-fourth aspect of the present invention, there is provided the display panel pattern forming method as defined in the third aspect, wherein, when the discharge of the paste is interrupted in the semi-effective display area, this discharge interruption is performed by utilizing generation of a negative pressure attendant on an increase in a gap of an internal passage of the dispenser.

### BRIEF DESCRIPTION OF THE DRAWINGS

These and other aspects and features of the present invention will become clear from the following description taken in conjunction with preferred embodiments thereof with reference to the accompanying drawings, in which:

FIG. 1 is a schematic perspective view in which a pattern forming apparatus for executing a pattern forming method of a display panel of the present invention is applied as a first embodiment to a fluorescent material layer forming apparatus of a PDP substrate;

FIG. 2 is a view showing an effective display area and a non-effective display area of the PDP substrate;

FIG. 3 is a sectional front view showing a dispenser to which the first embodiment of the present invention is applied;

FIG. 4 is a graph showing a moving velocity of the dispenser with respect to time in the first embodiment;

FIG. 5A is a graph showing a thread groove revolution number basic component with respect to time in the first embodiment, FIG. 5B is a graph showing a thread groove revolution number correction component with respect to time in the first embodiment, and FIG. 5C is a graph showing a thread groove revolution number with respect to time in the first embodiment;

FIG. 6 is a sectional front view showing a dispenser to which a second embodiment of the present invention is applied;

FIG. 7 is a detailed view of a discharge portion of FIG. 6;

FIG. 8 is a graph showing piston displacement with respect to time in the second embodiment;

FIG. 9 is a graph showing thread groove pressure with respect to time in the second embodiment;

FIG. 10 is a graph showing squeeze pressure with respect to time in the second embodiment;

FIG. 11 is a graph showing discharge nozzle upstream-side pressure with respect to time in the second embodiment;

FIG. 12 is a sectional front view showing a dispenser to which a third embodiment of the present invention is applied;

FIG. 13 is a detailed view of a flow rate control portion of FIG. 12;

FIG. 14 is a graph showing a discharge flow rate with respect to time in the third embodiment;

FIG. 15 is a diagram showing an electrical circuit model of the flow rate control portion in the third embodiment;

FIG. 16 is a schematic perspective view in which a number of screen stripes are simultaneously drawn by applying the pattern forming apparatus of the present embodiment to a CRT fluorescent material layer forming apparatus, a PDP substrate pattern forming apparatus, or the like;

FIG. 17 is a sectional front view showing a dispenser to which a fourth embodiment of the present invention is applied;

FIGS. 18A and 18B are a graph and a view showing displacement of a piston and a sleeve with respect to time in the fourth embodiment;

FIG. 19 is a graph showing discharge nozzle upstream-side pressure with respect to time in the fourth embodiment;

FIG. 20 is a sectional front view showing a dispenser to which a fifth embodiment of the present invention is applied;

FIG. 21 is an enlarged view of a pump portion in the fifth embodiment;

FIGS. 22A, 22B and 22C are views and a graph showing relationships between seal pressure and a gap in the fifth embodiment;

FIG. 23 is a schematic perspective view of a dispenser system fluorescent material layer forming apparatus proposed conventionally;

FIG. 24 is a view showing a conventional air system dispenser;

FIG. 25 is an explanatory view for explaining a state in which a plurality of coating lines are concurrently drawn with a plurality of micro dispensers by the pattern forming apparatus of FIG. 16;

FIG. 26 is an explanatory view for explaining a state in which electrode lines for a PDP substrate are drawn by the pattern forming apparatus corresponding to FIG. 25;

FIG. 27 is a perspective view of a pattern forming apparatus according to another embodiment of the present invention, in which a panel is moved with a dispenser fixed; and

FIG. 28 is a view showing an effective display area and a non-effective display area of the PDP substrate according to a modification example of FIG. 2.

### DETAILED DESCRIPTION OF THE PREFERRED EMBODIMENTS

Before description of the present invention proceeds, it is to be noted that like parts are designated by like reference numerals throughout the accompanying drawings.

Embodiments according to the present invention will be described in detail below with reference to the drawings.

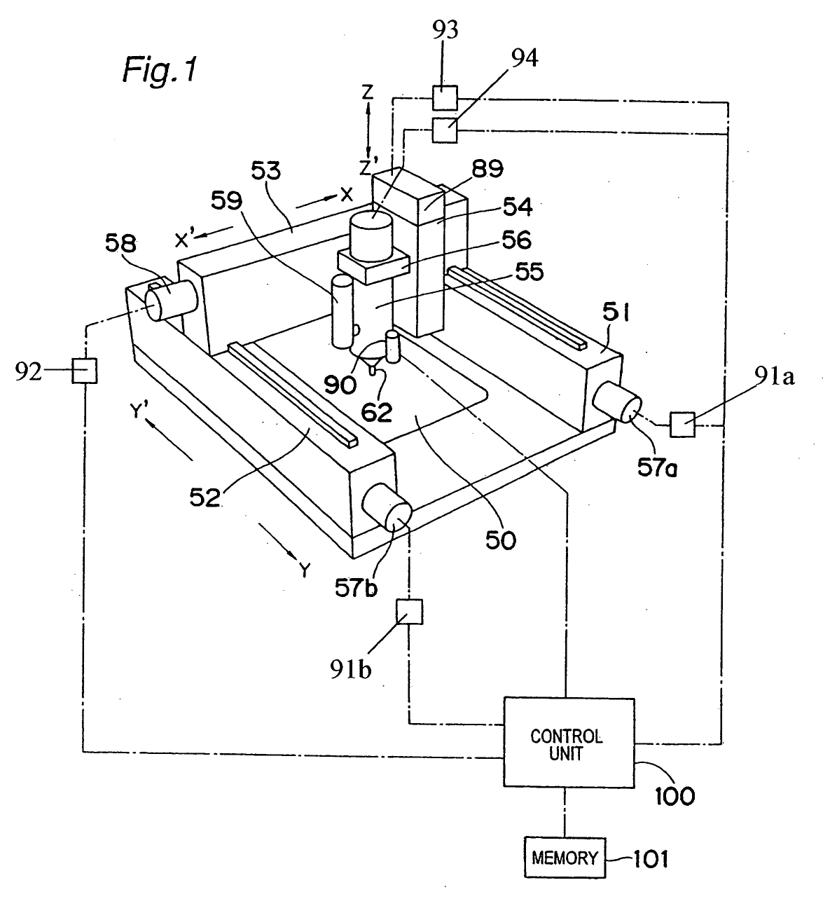

A first embodiment of an application of a method and apparatus of forming a pattern of a display panel of the present invention to a method and apparatus of forming a fluorescent material layer on a PDP substrate 61 of a plasma display panel (PDP hereinafter) will be described below with reference to the schematic perspective view of FIG. 1.

Reference numeral 50 denotes a baseplate on which the PDP substrate 61, that constitutes a part of a panel, is to be placed, and the baseplate is constructed of, for example, a mere fixed plate or an X-Y stage capable of positioning and holding the PDP substrate 61. A pair of Y-axis direction transport units 51 and 52 is provided on both sides with interposition of the baseplate 50. Moreover, an X-axis direction transport unit 53 is mounted movably in a Y-Y′ direction on the Y-axis direction transport units 51 and 52. Further, a Z-axis direction transport unit 54 is mounted movably in an X-X′ arrow direction on the X-axis direction transport unit 53.

A syringe mounting portion 56 to which a dispenser 55 is detachably attached is mounted movably in a Z-Z′ direction on the Z-axis direction transport unit 54.

The Y-axis direction transport units 51 and 52 transport the X-axis direction transport unit 53 in the Y-Y′ direction by driving Y-axis motors 57a and 57b, each of which is provided with an encoder. Pieces of output information (in other words, transport positional information) from the encoders are inputted to a control unit 100 and used for operational control of the Y-axis motors 57a and 57b and so on.

Moreover, the X-axis direction transport unit 53 transports the Z-axis direction transport unit 54 in the X-X′ direction by driving an X-axis motor 58 provided with an encoder. Output information (in other words, transport positional information) from the encoder is inputted to the control unit 100 and used for operational control of the X-axis motor 58 and so on.

The Z-axis direction transport unit 54 transports the syringe mounting portion 56 in the Z-Z′ direction by driving a Z-axis motor 89 provided with an encoder. Output information (in other words, transport positional information) from the encoder is inputted to the control unit 100 and used for operational control of the Z-axis motor 89 and so on.

The Y-axis motors 57a and 57b are connected via motor drivers 91a and 91b, the X-axis motor 58 is connected via a motor driver 92, the Z-axis motor 89 is connected via a motor driver 93, and the dispenser 55 is connected via a dispenser controller 94, respectively, to the control unit 100. Operations of the Y-axis motors 57a and 57b, the X-axis motor 58, the Z-axis motor 89, and the dispenser 55 are controlled by the control unit 100 on a basis of output information received from respective encoders.

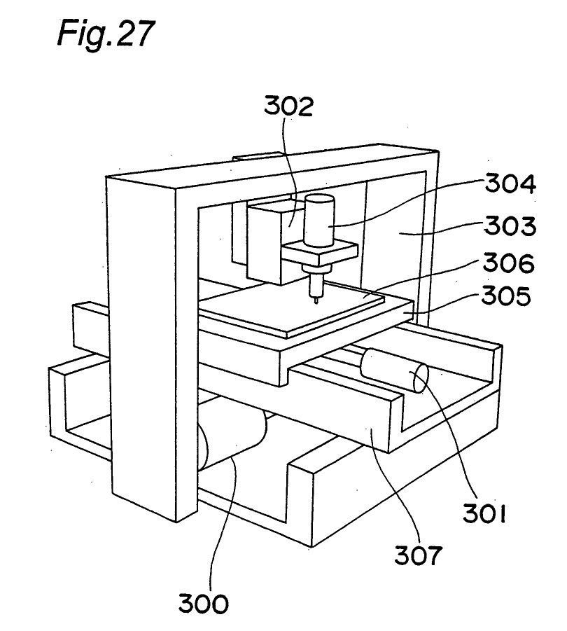

There is provided construction of one example of a transport section where the discharge nozzle is moved relatively to the baseplate 50 by the X-axis direction transport unit 53 and the Y-axis direction transport units 51 and 52. As another example of a transport section, there is an X-Y table, which is shown in FIG. 27 and described later.

A substrate position detection camera 90 of a CCD sensor, a line sensor, or the like is fixed as one example of a substrate imaging device on the dispenser 55, and image information picked up by the substrate position detection camera 90 is inputted to the control unit 100. A memory 101 for storing data, a program and so on is connected to the control unit 100.

A fluorescent material layer is formed on the PDP substrate 61 by the aforementioned pattern forming apparatus that has the aforementioned construction.

First of all, a syringe 59 that accommodates a paste-form fluorescent material for formation of a red (R) fluorescent material layer is detachably attached to the dispenser 55.

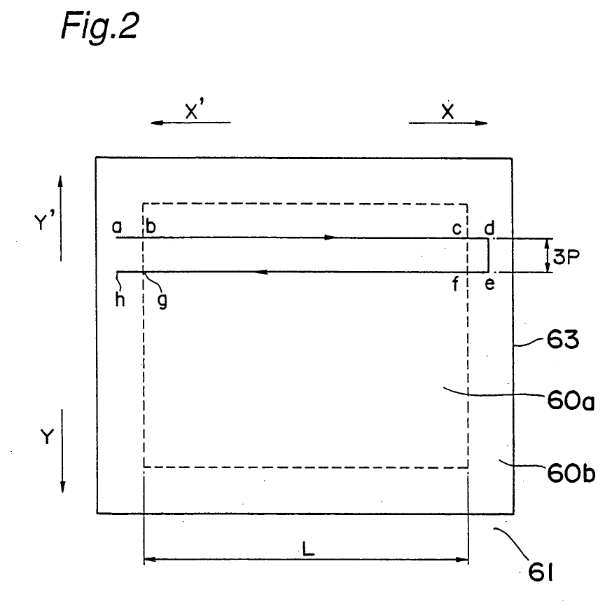

As shown in FIG. 2, the PDP substrate 61 has an effective display area 60a in which a fluorescent material layer corresponding to an effective display area of the PDP is to be formed, and a non-effective display area 60b which is arranged outside, or for example, outside a peripheral portion of this effective display area 60a and in which no fluorescent material layer is to be formed. This substrate 61 is placed and fixed in a prescribed position of the baseplate 50.

For example, in the case of a 42-inch PDP substrate, 1921 ribs (a photoabsorption layer) having a length L=560 mm, a height H=100 μm, and a width W=50 μm are preliminarily formed at intervals of a pitch P parallel to the X-X′ direction in the effective display area 60a of the substrate 61 constructed of a 3.0-mm thick glass plate. Since 1920 grooves are formed between these 1921 ribs, R, G, and B fluorescent materials are to be each coated into 640 (=1920/3) grooves.

As a preparatory operation, a method for determining a position of streaks of the fluorescent material layer to be deposited on the PDP substrate 61 by the dispenser 55 will be described first.

For example, positioning marks (alignment marks) formed in two places (for example, diagonally opposed two places) or three places of approximately quadrangular PDP substrate 61 are each detected by using, for example, the substrate position detection camera 90.

Next, positional information of a photoabsorption layer of the PDP substrate 61 is detected by the substrate position detection camera 90. At this time, the photoabsorption layer is detected by a transmitted light that has been projected from baseplate 50 side and penetrated the PDP substrate 61, or reflection of a projection light provided on the dispenser 55 side on PDP substrate 61. By executing image processing if necessary, black and white are clarified. This obtained positional information of the photoabsorption layer is stored into the memory 101 by the control unit 100. At this time, it is acceptable to detect all photoabsorption layers, or detect a part of the photoabsorption layers properly selected from all the photoabsorption layers, and roughly analogize positional information of the other photoabsorption layers.

Moreover, it is acceptable to preliminarily store the positional information of the photoabsorption layers in the memory 101 and read this stored positional information of the photoabsorption layers by the control unit 100, instead of performing a detection operation of the photoabsorption layers.

Next, an X-Y coordinate of a coating start position b (position in which a stripe starts to be drawn) seen from coordinate axes of the above pattern forming apparatus is determined on the basis of the photoabsorption layer positional information with reference to the positional information of the alignment marks. In this case, the X-Y coordinate of the coating start position b is determined with reference to the positional information of the alignment marks, and thereafter, on the basis of the positional information (for example, information of distance between position b and a position c) of the photoabsorption layer, the X-Y coordinates of other positions (positions such as preparatory position a, coating start position b, coating end position c, angle position d, angle position e, coating start position f, coating end position g, angle position h, . . . ) are determined. In this case, the coating start position g, the coating end position c, the coating start position f and the coating end position g are boundary positions between the effective display area 60a and the non-effective display area 60b. The angle position d, the angle position e and the angle position h are positions in which the dispenser 55 is moved so as to angle by switching between the X- or X′-direction and the Y- or Y′-direction.

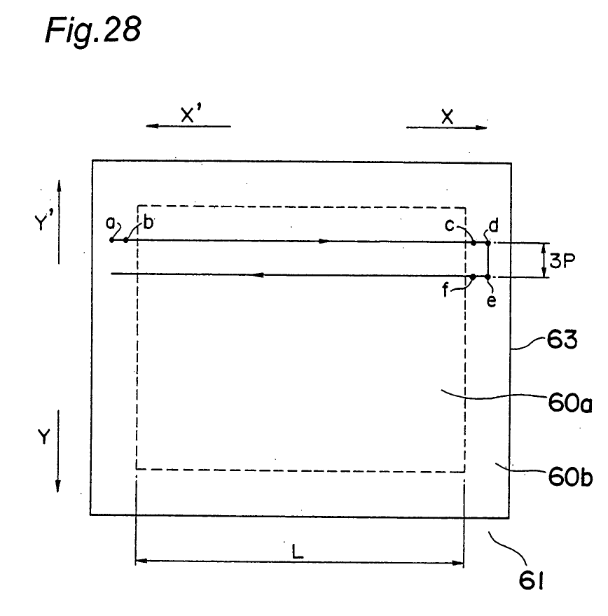

As a modification example of FIG. 2, FIG. 28 shows a case where the coating start position b, the coating end position c, and the coating start position f are located not in the boundary between the effective display area 60a and the non-effective display area 60b but in the non-effective display area 60b. Therefore, generally speaking, the coating start position and the coating end position are located either in arbitrary positions inside the non-effective display area 60b or in boundary positions between the effective display area 60a and the non-effective display area 60b, and the angle positions are located always in arbitrary positions inside the non-effective display area 60b.

Next, in detecting photoabsorption layer positional information, Z-axis information (information of a distance between a nozzle tip of the dispenser 55 and its opposite surface, including information of undulation, warp, and the like) is also read by using a laser or the like according to circumstances. This Z-axis information is necessary for driving the Z-axis motor so that a distance between the nozzle tip of the dispenser 55 and its opposite surface becomes constant when the PDP substrate 61 has an undulation or in the case of a curved surface. Also, in this case, it is acceptable to preliminarily store previously detected Z-axis information in the memory 101 and read this stored Z-axis information by the control unit 100, instead of directly reading the Z-axis information by using the laser or the like.

Discharge operation under control of the control unit 100 will be described next.

First, the dispenser 55 is moved to the preparatory position a for the start of coating an R (red) fluorescent material (hereinafter referred to as an “R fluorescent material”), and the Z-axis motor 89 is driven to position a tip of the discharge nozzle 62 at a prescribed height under operational control of the control unit 100 on the basis of Z-axis information.

Next, the X-axis motor 58 is driven to move the discharge nozzle 62 in the direction of the arrow X under control of the control unit 100, and it is detected that the discharge nozzle 62 is located in the coating start position b by the control unit 100 according to output information received from the encoder of the X-axis motor 58. Then, simultaneously with the start of the discharge of the R fluorescent material from the discharge nozzle 62 under control of the control unit 100, the discharge nozzle 62 is further moved at a constant velocity in the direction of the arrow X to start fluorescent material coating in a stripe form on the PDP substrate 61. The discharge nozzle 62 draws a coating line only by length L (FIG. 2) of one rib, and it is detected that the tip of the discharge nozzle 62 has reached the coating end position c where the nozzle tip enters the non-effective display area 60b from the effective display area 60a by the control unit 100 according to output information received from the encoder of the X-axis motor 58. Then, discharge of the fluorescent material is stopped under control of the control unit 100. Subsequently, the discharge nozzle 62 further continues moving in the X-direction under control of the control unit 100, and it is detected that the nozzle has reached the angle position d by the control unit 100 according to output information received from the encoder of the X-axis motor 58. Then, driving of the X-axis motor 58 is stopped to stop movement of the discharge nozzle 62 in the X-direction.

Next, the Y-axis motors 57a and 57b are synchronously driven under control of the control unit 100 with discharge of the fluorescent material by the nozzle 62 stopped, and the discharge nozzle 62 moves in the direction of the arrow Y by 3P (i.e., an interval three times the arrangement pitch P of the ribs (or the photoabsorption layer)) from the angle position d to the angle position e. That is, upon detecting an event, that the discharge nozzle 62 has reached the angle position e by the control unit 100, according to output information received from the encoders of the Y-axis motors 57a and 57b under control of the control unit 100, driving of the Y-axis motors 57a and 57b is stopped to stop movement of the discharge nozzle 62 in the Y-direction.

Next, the X-axis motor 58 is driven again under control of the control unit 100 to start movement of the discharge nozzle 62 in the X′-direction from the angle position e to the coating start position f. Upon detecting an event, that the discharge nozzle 62 has reached the coating start position f, by the control unit 100, according to output information from the encoder of the X-axis motor 58, simultaneously with a restart of discharge of the R fluorescent material from the discharge nozzle 62, the discharge nozzle 62 is further moved at a constant velocity in the direction of the arrow X′ to restart the fluorescent material coating in stripe form on the PDP substrate 61. The discharge nozzle 62 draws a coating line by length L (FIG. 2) of one rib, and it is detected, that the tip of the discharge nozzle 62 has reached the coating end position g where the nozzle tip enters the non-effective display area 60b from the effective display area 60a, by the control unit 100, according to output information received from the encoder of the X-axis motor 58. Then, discharge of the fluorescent material is stopped under control of the control unit 100. Subsequently, the discharge nozzle 62 further continues moving in the X′-direction under control of the control unit 100, and it is detected, that the nozzle has reached the angle position h by the control unit 100, according to output information received from the encoder of the X-axis motor 58. Then, driving of the X-axis motor 58 is stopped to stop movement of the discharge nozzle 62 in the X′-direction.

In this case, reading the angle position h as preceding angle position d, the nozzle moves in the direction of the arrow Y by 3P (i.e., the interval three times the arrangement pitch P of the ribs (or the photoabsorption layer)) to a new preparatory position a. The aforementioned steps are repeated again and again, and work of the R fluorescent material ends when the number of coating lines becomes 640.

The above are basic steps of the fluorescent material coating. As for coating of remaining G (green) fluorescent material (hereinafter referred to as a “G fluorescent material”) and the B (blue) fluorescent material (hereinafter referred to as a “B fluorescent material”), it is acceptable to successively transport the PDP substrate 61 to a G fluorescent material pattern forming apparatus having a baseplate provided specially for the G fluorescent material, and a B fluorescent material pattern forming apparatus having a baseplate provided specially for the B fluorescent material. These apparatuses are separately provided, and perform pattern forming with respective pattern forming apparatuses. Otherwise, it is acceptable to provide the Z-axis direction transport unit 54 of an identical pattern forming apparatus with dispensers of three kinds (for the fluorescent material coating of R (red), G (green), and B (blue) colors) and perform a fluorescent material discharge operation for each of the colors.

As described above, control of an application quantity synchronized with the start and end positions (coating start position b, coating end position c, coating start position f, coating end position g, and the like) of the discharge nozzle 62, the coating start and end timing and moving velocity of the dispenser, i.e., the discharge nozzle 62, is executed by the control unit 100 on the basis of a pre-programmed start and end position information, and displacement and velocity information from the discharge nozzle 62. When work of forming the fluorescent material layers of R, G, and B along an inner configuration of the grooves between the ribs thus wholly ends, the tip position of the discharge nozzle 62 of the dispenser 55 returns to a home position (for example, the preparatory position a in FIG. 2). When a coating process of the screen stripe ends as described above, the substrate 61 is transported, and thereafter, processing proceeds to a fluorescent material drying process.

[1] Thread Groove Type Dispenser

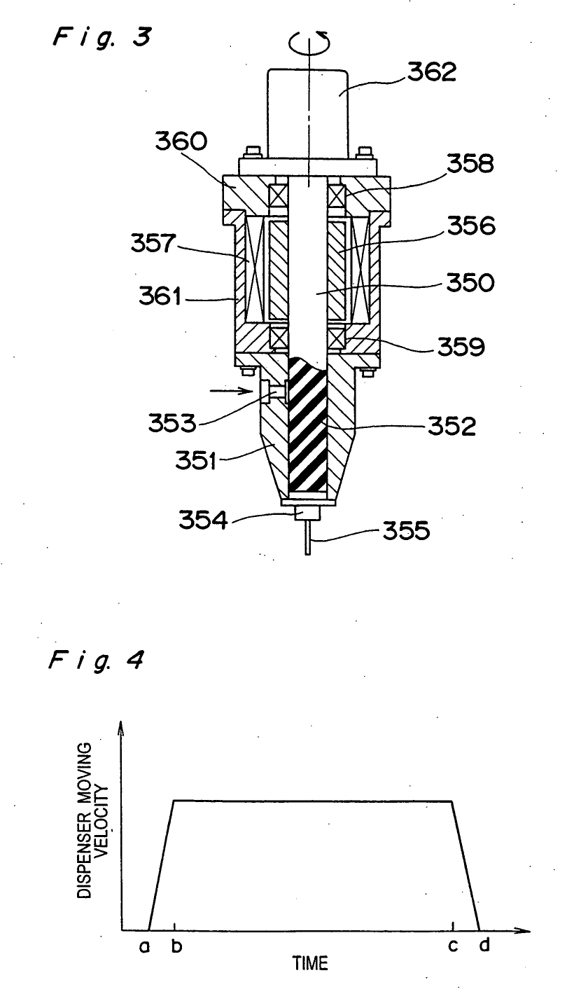

A more concrete structure of the method and apparatus of forming a fluorescent material layer on the PDP substrate 61 according to the first embodiment of the present invention will be described with reference to FIGS. 3 through 5C.

In FIG. 3, reference numeral 350 denotes a revolving shaft of a thread groove type dispenser (corresponding to the dispenser 55 of the foregoing description), 351 a sleeve that accommodates a discharge side of this revolving shaft, 352 a thread groove (groove portion is painted in black) formed on an inner surface of this sleeve 351 and relative displacement surface of the revolving shaft 350, 353 an inlet port formed at the sleeve 351, 354 a discharge portion arranged at a tip of the sleeve 351, 355 a discharge nozzle (corresponding to the discharge nozzle 62 of the foregoing description) provided for this discharge portion 354, 356 a motor rotor fixed on the revolving shaft 350, 357 a motor stator, 358 and 359 bearings for supporting the revolving shaft 350, 360 and 361 upper and lower housings that accommodate the bearings 358 and 359 and the motor stator 357, and 362 an encoder that detects an amount of revolutions (revolution number) of the motor and outputs the same to the control unit 100.

The screen stripe forming method of the first embodiment is as follows. Referring to FIG. 2, it is assumed that the tip of the discharge nozzle 355 is located inside the non-effective display area 60b [see the preparatory position a in FIG. 2] when the discharge nozzle 355, or, in other words, the thread groove type dispenser starts running. Normally, there is needed a time constant of 0.01 to 0.1 seconds until the dispenser reaches a steady velocity after the X-axis direction transport unit 53, which is the drive unit of the dispenser, starts driving. A magnitude of the time constant of this control system is determined depending on a mass of a loaded object to be transferred, power of the motor, magnitude of vibration permitted in a transient state, and so on. The following descriptions are based on two different cases: [1] when a moving velocity of the dispenser reaches a steady velocity in the non-effective display area; and [2] when a moving velocity of the dispenser reaches a steady velocity in the effective display area.

[1] When Steady Velocity is Achieved in the Non-Effective Display Area:

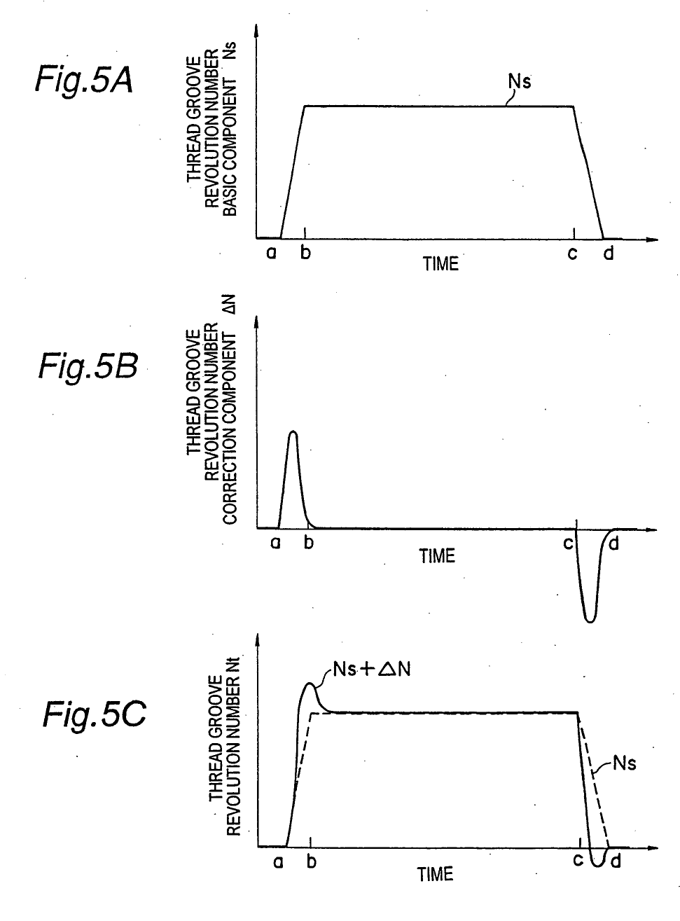

FIG. 4 shows the “dispenser moving velocity with respect to time” in the first embodiment. FIG. 5C shows the “relationship between the thread groove revolution number and time”, where Ns represents a basic input waveform that is a basic component of the thread groove revolution number. It is to be noted that “a, b, c, and d” on the abscissa axis of FIGS. 4 through 5C represent times for passing through the preparatory position a, the coating start position b, the coating end position c, and the angle position d, respectively.

A total amount per unit length of the coating line coated on the substrate 61 is inversely proportional to the velocity of the dispenser. Moreover, attention is paid to the fact that the revolution number of the thread groove and discharge flow rate Q are linearly proportional to each other in a steady state. Therefore, the basic input waveform: Ns, which is the basic component of the thread groove revolution number, is set according to a relational equation inversely proportional to the dispenser velocity: Vs in the first embodiment.

In the first embodiment, when velocity of the dispenser is sufficiently low, a continuous line including the start and end points can be coated without trouble by using the basic input waveform: Ns of revolution number.

However, when, for example, velocity of the dispenser is set to be Vs>100 mm/sec in order to improve a production cycle time, issues described as follows occur.

(1) Issue at the Coating Start Time

Simultaneously with a relative shift of the nozzle tip to the effective display area, revolution of the revolving shaft 350 on which the thread groove 352 is formed steeply starts. At this time, no drawing line can be drawn on the substrate 61 simultaneously with the start of revolution, and defects of lack, thinning, and the like of the coating line occur until a continuous drawing line can be satisfactorily drawn. Reasons for the above are as follows. Fluid, which has flowed out of the tip of the discharge nozzle 355, cannot separate from the discharge nozzle 355 because of a small flow velocity immediately after start of outflow, and a fluid mass due to surface tension is formed at the nozzle tip. The surface tension is overcome when flow velocity increases to increase kinetic energy of the coating fluid, and the fluid separates from the nozzle 355. At this time, the fluid mass at the nozzle tip concurrently drops onto the substrate 61, and therefore, a drip portion occurs after the lack and thinning of the coating line.

(2) Issue at a Coating End Time

The following phenomena occur at the coating end point. Revolution of the thread groove 352 is steeply reduced before a relative shift of the nozzle tip from the effective display area 60a to the non-effective display area 60b. As a result, coating on the substrate 61 stops. However, fluid outflow from the nozzle tip does not completely stop, and therefore, a fluid mass at the nozzle tip keeps growing even when the nozzle 355 is running through a U-turn interval (for example, an interval from the angle position d to the angle position e).

If revolution is started before the shift of the nozzle tip from the non-effective display area 60b to the effective display area 60a, then spot forming of the fluid mass at the nozzle tip first occurs.

Subsequently, lack, thinning, and so on of the coating line occurs as described above.

With regard to the aforementioned issues (1) and (2), the aforementioned issues of the start and end portions are solved by the following method in the first embodiment.

The thread groove 352 is revolved by an input waveform Ns (FIG. 5C) obtained by adding a correction term (correction component) ΔN (FIG. 5B) to the basic input waveform Ns (FIG. 5A) of the thread groove revolution number. The correction term AN is to correct a transitional flow rate characteristic of the dispenser. At the coating start point, revolution of thread groove 352 is accelerated and thereafter promptly put back to a steady revolution. As a result, a large kinetic energy, which overcomes surface tension immediately after start of discharge, is applied to the fluid, and therefore, coating can be started without making a fluid mass at the nozzle tip.

At the coating end point, revolution of the thread groove 352 is rapidly decelerated and stopped as shown in FIG. 5C. As a result, a fluid mass at the nozzle tip can be minimized and spot forming at the coating start time can be prevented, in a stage prior to the run through the U-turn interval (non-effective display area 60b).

Moreover, by keeping the state in which the fluid mass at the nozzle tip is slightly sucked into the nozzle with the thread groove 352 gradually reversely revolved during the run through the U-turn interval, spot forming at the coating start time can be prevented more effectively.

[2] When Steady Velocity is Achieved in the Effective Display Area:

In this case, similarly to the case of [1], it is proper to revolve the thread groove by input waveform Nt obtained by adding the correction term ΔN for preventing a discharge delay at a coating start time and occurrence of fluid mass at a coating end time to the basic input waveform Ns determined in proportion to a moving velocity of the dispenser.

When the screen stripe is formed by a direct drawing method by use of the aforementioned dispenser, it is preferable to arrange a plurality of dispensers from a viewpoint of production cycle time. In this case, it is a big issue as to how flow rates of the dispensers are made to coincide with one another. Even if dimensional specifications of the dispensers including pump portions, driving conditions of the motor, and so on are set same, it is often the case where variations occur in the flow rates of the dispensers. In the first embodiment, if revolution numbers of respective dispensers are individually corrected by δNs on the basis of the basic revolution number: Ns of the motor taking advantage of the fact that a flow rate is almost proportional to the revolution number of the thread groove, then coincidence of the flow rates can be achieved. Moreover, even when a difference in the flow rate characteristic between the fluorescent materials of R, G, and B causes a flow rate difference, the difference can be corrected by setting of a revolution number of the motor. This method can also be applied to second through fifth embodiments that employ a thread groove type described hereinbelow.

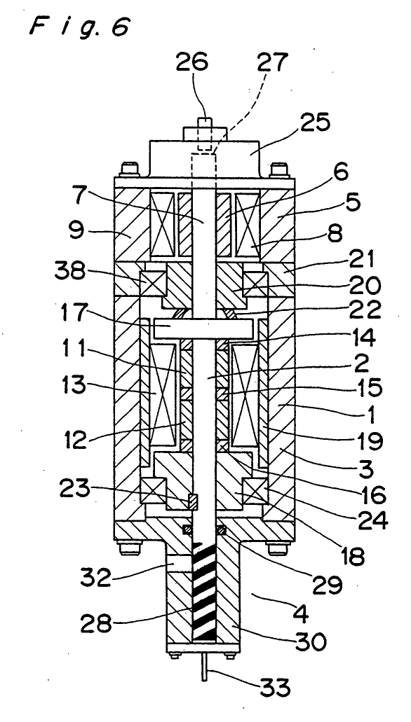

A dispenser applied to the fluorescent material layer forming method and forming apparatus according to a second embodiment of the present invention will be described below with reference to FIGS. 6 through 11.

The dispenser of the second embodiment described below has a “two-degree-of-freedom actuator”, which concurrently produces a relative rotary motion and a rectilinear motion between a piston and a sleeve that accommodates the piston. Operation is as follows.

(1) Positive and negative squeeze pressures are generated on a discharge side end surface of the piston by rectilinearly driving the piston by use of a first actuator.

(2) A pumping pressure is generated by revolving the piston on which a thread groove is formed by a second actuator that produces a rotary motion, and a coating fluid is pressure-fed to the discharge side.

By combining the aforementioned operative actions (1) and (2) with each other, high-speed interruption and high-speed release control of a coating line in a boundary portion between the effective display area and the non-effective display area is achieved.

In FIG. 6, reference numeral 1 denotes a first actuator, which is provided by a giant-magnetostrictive element capable of obtaining a high positioning accuracy, possessing a high responsability and obtaining a great generated load in this second embodiment. Reference numeral 2 denotes a main shaft (piston) driven by the first actuator 1. The first actuator 1 is housed in a housing 3, and a pump portion 4 that accommodates the main shaft 2 is mounted in a lower end portion (on a front side) of this housing 3.

Reference numeral 5 denotes a second actuator, which produces a relative rotary motion between the main shaft 2 and the housing 3. A motor rotor 6 is fixed on an upper main shaft 7, and a motor stator 8 is housed in an upper housing 9.

Reference numerals 11 and 12 denote a rear side giant-magnetostrictive rod and a cylindrical front side giant-magnetostrictive rod, respectively, the rods being respectively constructed of a giant-magnetostrictive element. Reference numeral 13 denotes a magnetic field coil for applying a magnetic field in a lengthwise direction of the giant-magnetostrictive rods 11 and 12. Reference numerals 14, 15, and 16 denote permanent magnets provided on a rear side, in an intermediate portion, and on a front side, respectively, for applying a bias magnetic field to the giant-magnetostrictive rods 11 and 12. The permanent magnets 14 and 16 located on the rear side and the front side are arranged in a form such that they hold the giant-magnetostrictive rods 11 and 12 and the intermediate permanent magnet 15 therebetween.

These permanent magnets 14 through 16 are to improve an operating point of a magnetic field by preliminarily applying the magnetic field to the giant-magnetostrictive rods 11 and 12, and linearity of giant-magnetostriction with respect to magnetic field intensity can be improved by this magnetic bias.

Reference numeral 17 denotes a rear side yoke, which is a yoke member of a magnetic circuit and arranged on a rear side of the giant-magnetostrictive rod 11, 18 denotes a front side sleeve, which concurrently serves as a yoke member and is arranged on a front side of the giant-magnetostrictive rod 12, and 19 denotes a cylindrical yoke member arranged outside a peripheral portion of the magnetic field coil 13.

A closed-loop magnetic circuit, which controls extension and retraction of the giant-magnetostrictive rods 11 and 12, is formed through a loop of the giant-magnetostrictive rod 12→the permanent magnet 15→the giant-magnetostrictive rod 11→the permanent magnet 14→the rear side yoke 17→the yoke member 19→the front side sleeve 18→16→the giant-magnetostrictive rod 12. It is to be noted that a nonmagnetic material is used for the main shaft 2 in order to not exert influence on this magnetic circuit. That is, a giant-magnetostrictive actuator (first actuator 1), which can control extension and retraction in an axial direction of the giant-magnetostrictive rods 11 and 12 by an electric current given to the magnetic field coil 13, is constructed of the giant-magnetostrictive rods 11 and 12, the magnetic field coil 13, the permanent magnets 14 through 16, the rear side yoke 17, the front side sleeve 18, and the yoke member 19.

Reference numeral 20 denotes a rear side sleeve, which accommodates the upper main shaft 7 rotatably and movably in the axial direction. This rear side sleeve 20 is also rotatably supported by bearing 38 in an intermediate housing 21.

Reference numeral 22 denotes a bias spring mounted between the rear side yoke 17 and the rear side sleeve 20. By an axial load applied from this bias spring 22, the giant-magnetostrictive rods 11 and 12 are held while being pressurized via the bias permanent magnets 14 through 16 by rear side yoke 17 and the front side sleeve 18 located on upper and lower sides.

As a result, a compressive stress is always applied to the giant-magnetostrictive rods 11 and 12 in the axial direction. Therefore, when a repetitive stress is generated, a drawback of the giant-magnetostrictive element being susceptible to a tensile stress is canceled.

The front side sleeve 18 accommodates the main shaft 2 movably in the axial direction. Rotary power of the main shaft 2 transmitted from the motor 5 is transmitted to the front side sleeve 18 by a revolution transmission key 23 provided between the main shaft 2 and the front side sleeve 18. Moreover, the front side sleeve 18 is also rotatably supported by a bearing 24 in the housing 3.

With the aforementioned construction, rotary power of the motor 5 is transmitted only to the main shaft 2 and the front side sleeve 18, and no torsional torque is generated in the giant-magnetostrictive elements that are of brittle material.

Moreover, the giant-magnetostrictive elements 11 and 12 and the permanent magnets 14 through 16, which are formed in a ring-like form, are arranged so as to penetrate the main shaft 2 of nonmagnetic material. Moreover, a gap between a peripheral portion of the main shaft 2 and inner peripheral portions of the giant-magnetostrictive rods and the permanent magnets is set sufficiently small. As a result, due to influence of centrifugal forces applied to respective members during revolution of this device, axial centers of the giant-magnetostrictive rods and the permanent magnets do not largely deviate.

That is, the main shaft 2 provided penetratively through members concurrently has a “protective function” to apply nothing but a compressive stress to the giant-magnetostrictive elements that are of brittle material, and an “axial center deviation preventive function” during revolution.

Reference numeral 25 denotes an encoder for detecting rotational positional information of the upper main shaft 7, which is the second actuator and arranged above the motor 5. Reference numeral 26 denotes a displacement sensor for detecting axial displacement of an upper end surface 27 of the upper main shaft 7 (and the main shaft 2).

With the aforementioned arrangement, there can be provided a “two-degree-of-freedom complex-motion actuator”, which can concurrently independently effect rotary motion and control of rectilinear motion of a minute displacement. Further, the giant-magnetostrictive element is employed as the first actuator in this second embodiment, and therefore, power for rectilinearly moving the giant-magnetostrictive rods 11 and 12 (and the main shaft 2) can be applied from outside in a non-contact manner.

An input current applied to the giant-magnetostrictive elements and displacement are proportional to each other, and therefore, axial positioning control of the main shaft 2 can be achieved even by open-loop control without a displacement sensor. However, if feedback control is performed by providing a position detection member (mechanism or device) as in the second embodiment, hysteresis characteristics of the giant-magnetostrictive elements can also be improved. Therefore, positioning can be performed with higher accuracy.

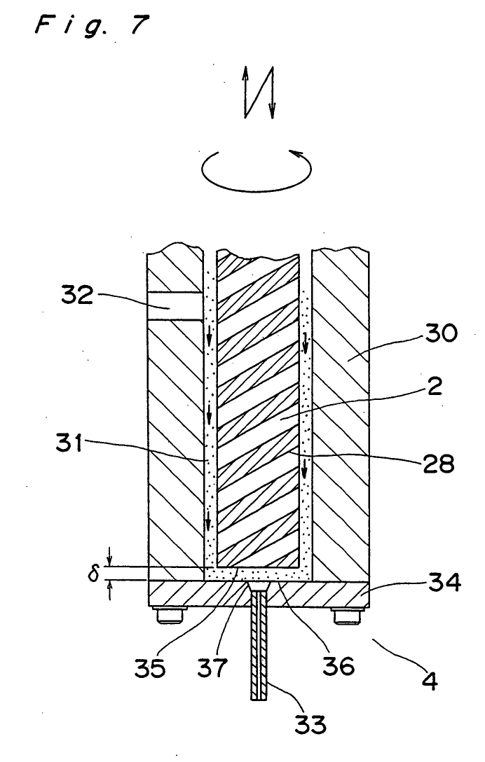

In the second embodiment, a size of a gap on a discharge side end surface of the main shaft 2 can be arbitrarily controlled by using an axial direction positioning function of the main shaft 2 with a steady revolution state of the main shaft 2 maintained. By using this function, control of interruption and release of particulate at start and end portions can be achieved with any interval of passage from the inlet port 32 to the discharge nozzle 33 put mechanically in a non-contact state. This principle will be described with reference to FIG. 7 which is a detailed view of the pump portion 4, and FIGS. 8 through 11 that show relationships between displacement of the piston and generated pressure.

In FIG. 7, reference numeral 28 denotes a radial groove (the groove portion is painted in black in FIG. 6, and the groove portion is hatched in FIG. 7) for pressure-feeding fluid formed at an external surface of the main shaft 2 to the discharge side, and 30 denotes a cylinder. Also, in FIG. 6 reference numeral 29 denotes a fluid seal.

A pump chamber 31 (fluid transport chamber) for obtaining a pumping action is formed, by revolution of the main shaft 2 relatively to the cylinder 30, between this main shaft 2 and the cylinder 30. Moreover, an inlet port 32 communicating with the pump chamber 31 is formed in the cylinder 30. Reference numeral 33 denotes a discharge nozzle mounted at a lower end portion of the cylinder 30, and 34 denotes a discharge plate fastened to a discharge side end surface of the cylinder 30. Reference numeral 35 denotes a discharge side end surface of the main shaft 2, and an opening 37 of the discharge nozzle 33 is formed in a central portion of an opposite surface 36 of the discharge side end surface 35 of the main shaft 2. A radial groove 28, which is a fluid pressure-feed member (mechanism or device) described with reference to FIG. 4, is well-known as a spiral groove hydrodynamic bearing and also utilized as a thread groove pump.

In the present embodiment, issues at start and end portions of a coating line are solved by the following method taking advantage of the fact that the main shaft 2 (hereinafter referred to as a piston) driven by the giant-magnetostrictive elements is able to rectilinearly move at high speed simultaneously with revolution.

(1) At a coating start time, revolution of the motor starts simultaneously with a rapid descent of the piston.

(2) At a coating end time, revolution of the motor is stopped simultaneously with rise of the piston.

In the second embodiment, the piston is driven by the giant-magnetostrictive elements. Therefore, a response of output displacement with respect to an input signal of the piston is on the order of 10⁻³ sec (at 1000 Hertz). Since time delay of generation of a squeeze pressure with respect to a change in a gap is little, response of a flow rate control is one digit to two digits higher than in a case of the first embodiment in which revolution number control is performed by the motor.

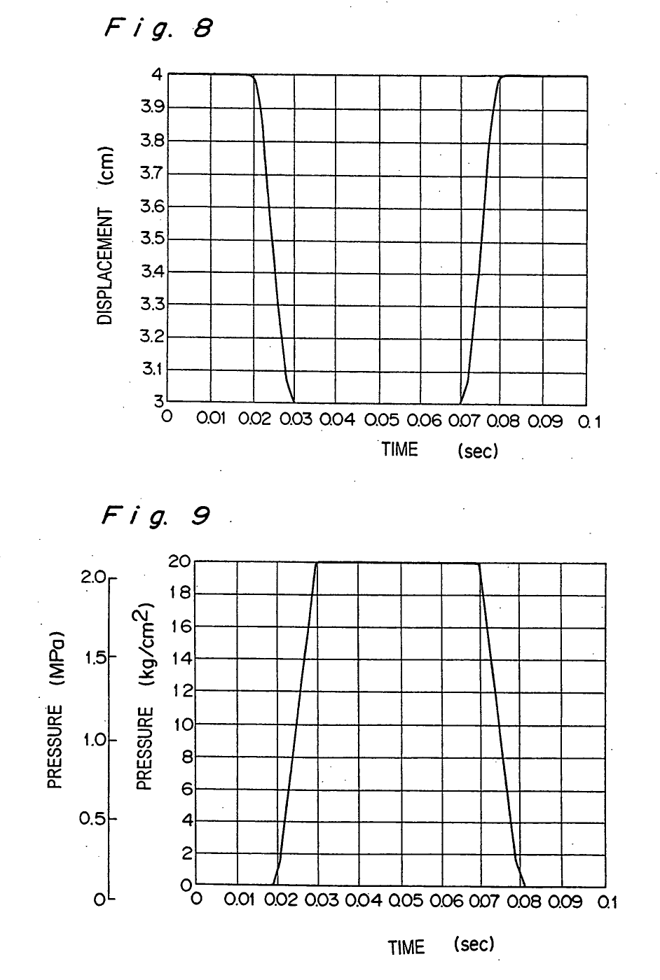

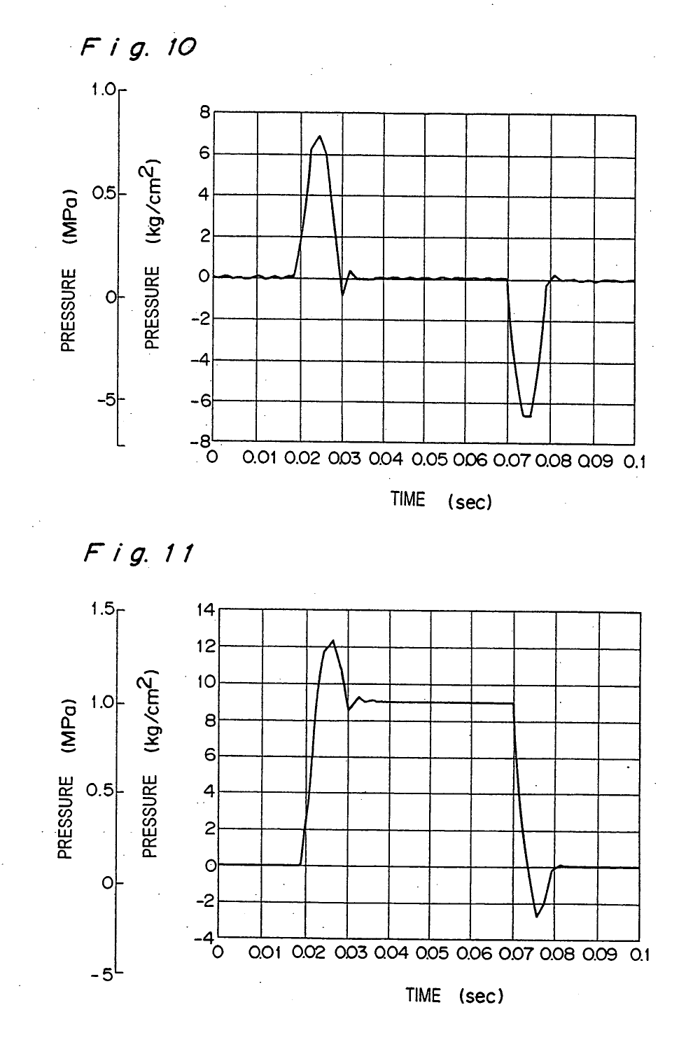

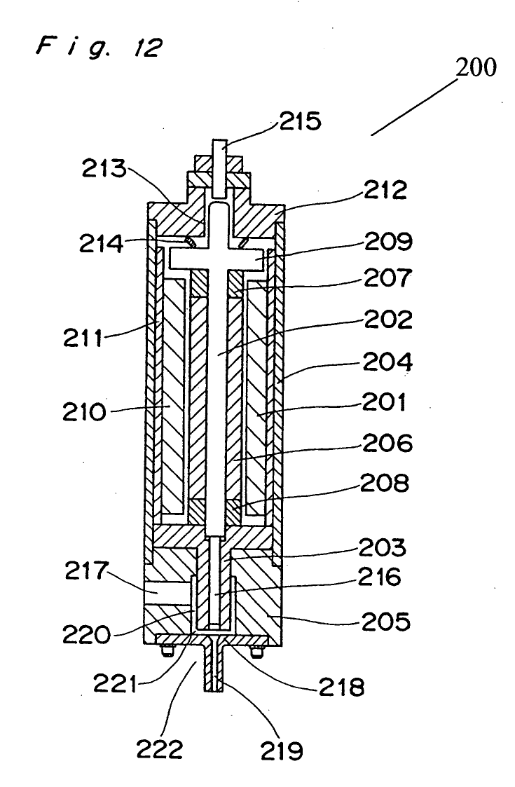

FIG. 8 shows a displacement curve of the piston driven by the giant-magnetostrictive elements, and FIG. 9 shows a pumping pressure Pp of the thread groove generated when the revolution number of the motor is increased (risen) from N=0 rpm to N=200 rpm. FIG. 10 shows an analytical result of a squeeze pressure Ps on an upstream side of the discharge nozzle generated by moving up and down the piston. FIG. 11 shows a pressure Pn (=Pp+Ps) obtained by combining the pumping pressure Pp of the thread groove with the squeeze pressure Ps. This squeeze pressure Ps is obtained by solving the Reynolds equation of the following equation (1) under conditions of Table 1.

$$\frac{\partial }{\partial x} ( \frac{{h}^{3}}{6 μ} \frac{\partial P}{\partial x} ) + \frac{\partial }{\partial y} ( \frac{{h}^{3}}{6 μ} \frac{\partial P}{\partial y} ) - ( \frac{\partial hU}{\partial x} + \frac{\partial hV}{\partial y} ) = 2 \frac{ⅆ h}{ⅆ t} \qquad ( 1 )$$

In equation (1), P is a pressure, μ is a viscosity coefficient of fluid, h is a gap between opposing surfaces, r is a position in a radial direction, t is time, U is an X-direction relative velocity, and V is a Y-direction relative velocity. The right side is the term that causes a squeeze action effect generated when the gap changes.

(1) At a Coating Start Time

In a state before the start of coating, revolution of the motor is stopped, and the piston is in a state in which the gap to the opposite surface: Xp=40 μm. If the piston quickly moves down with the gap: Xp=40→30 μm at t=0.02 sec, then the upstream side pressure: Pn of the discharge nozzle rapidly increases. A reason for the above is due to a squeeze action generated when the Reynolds equation of the equation (1) is dh/dt<0. The squeeze action is a sort of dynamic pressure effect of a fluid bearing that employs a viscous fluid. Due to steep generation of peak pressure (overshoot) by this squeeze effect, a large kinetic energy, which overcomes surface tension at the discharge nozzle tip, is applied to the fluid. Therefore, coating can be started without causing a fluid mass at the nozzle tip.

An overshoot pressure for smoothly drawing a coating line at the start point is larger as a stroke of the piston is larger and a rise time is shorter. That is, it is proper to set a magnitude of this overshoot pressure so that surface tension of the fluid at the discharge nozzle tip is overcome within a range in which “fattening” of the coating line does not occur at the start point.

(2) During a Steady State Run

During an interval of 0.03<t<0.07 sec, a continuous line is coated by constant rate discharge by pumping pressure Pb of revolution of the thread groove while the piston maintains a gap: Xp=30 μm to its opposite surface. Although there was also a fluid resistance between the piston and its opposite surface, discharge at a required flow rate was able to be achieved because the fluid resistance of the gap: Xp=30 μm was sufficiently small.

No squeeze pressure is generated in this interval. A reason for the above is that squeeze pressure is generated only when gap h is changing.

(3) At the Coating End Time

If the piston starts to move up simultaneously with deceleration of the motor at t=0.07 sec with the gap: Xp=30→40 μm, then the upstream side pressure Pn of the discharge nozzle is temporarily rapidly reduced as shown in FIG. 11. A reason for this rapid reduction of the pressure is that a gap of the gap portion formed of a thrust end surface and its opposite surface is still sufficiently narrow even when the piston quickly moves up and there is a fluid resistance in a centripetal direction between a peripheral portion and a central portion of the gap portion. Fluid is not easily replenished from the peripheral portion due to this fluid resistance, and pressure reduces. Theoretically, this is ascribed to the effect of, so to speak, a reverse squeeze action when dh/dt>0 in the Reynolds equation (equation (1)).

A reason for great negative pressure is that the Reynolds equation does not take compressibility of the fluid into consideration. Practically, fluid pressure does not become smaller than absolute pressure of zero (Pn<0.0 MPa) due to generation of bubbles and the like.

Due to this steep generation of negative pressure, not only fluid from the discharge nozzle is interrupted but also a suck-back effect to suck a slight amount of fluid mass at the nozzle tip to an interior of the nozzle can be obtained. Since revolution of the motor is stopped after generation of the negative pressure by the squeeze pressure, there is no discharge due to pumping pressure of the thread groove. Therefore, a meniscus of the fluid inside the nozzle continues maintaining the same position without forming a fluid mass at the nozzle tip while the nozzle is passing through the non-effective display area (U-turn interval). Therefore, a problem of dropping the fluid mass as described hereinabove can be avoided.

In this embodiment, a minimum gap between the piston and its opposite surface is set at Xmin=20 μm. A particle diameter of fluorescent material of the embodiment is φd=7 to 9 μm, and Xmin>φd. Therefore, fine particles of the fluorescent material are neither mechanically compressed nor damaged in a passage extended from the inlet port to the outlet port.

That is, when paste is interrupted, the gap between the piston and its opposite surface is formed larger than the particle diameter of the fine particles included in the material to be discharged. The minimum gap when the paste is interrupted is preferably not smaller than 8 μm in the passage extended from the inlet port to the discharge nozzle.

TABLE 1

| Parameters | Symbols | Specifications | |
|---|---|---|---|
| Fluid Viscosity | μ | 1000 | cps |
| Piston Diameter | Dp | 6 | mm |
| Sleeve Stroke | Xst | 10 | μm |
| Minimum Gap | Xmin | 20 | μm |
| between Piston | | | |
| and Opposite | | | |
| Surface | | | |
| Piston Descent | Tst | 0.01 | sec |
| Time | | | |
| Piston Ascent | Tst2 | 0.01 | sec |
| Time | | | |

In the second embodiment, the overshoot pressure and a suck-back pressure for smoothly drawing the start point and the end point of the coating line were able to be obtained by axial motion of the piston. In the second embodiment, a piston displacement curve (one example is shown in FIG. 8) can be set in an arbitrary shape. Moreover, the giant-magnetostrictive element for driving the piston, which has a high response, can sufficiently follow even if the displacement curve is steeply varied. That is, by virtue of displacement and velocity control of the giant-magnetostrictive element, it is enabled to perform fine control of discharge pressure and flow rate at the start and end portions, which cannot be achieved by revolution number control of the motor.

In the second embodiment, by combining control of axial displacement of the giant-magnetostrictive element with control of a revolution number of the motor, issues at the start and end portions of the continuous coating line can be solved, and a completely interrupted state in which no leak of material from the discharge nozzle occurs in the U-turn interval can be maintained for an arbitrary time. As described in connection with the first embodiment, it is acceptable to combine a method of adding the correction term AN to the basic input waveform Ns of the revolution number of the motor with the method of the second embodiment.

When the U-turn interval can be set sufficiently short, interruption of the flow rate at the end point and the release at the start point can be achieved by driving only the piston with revolution of the motor maintained as in an embodiment described later.

In the second embodiment, the pump section is constructed by giving both functions of axial movement and the revolution to the piston with the two-degree-of-freedom actuator that employed the giant-magnetostrictive element. In place of this construction, there may be a construction of forming, for example, a revolving shaft (outer peripheral side piston), which does not move in an axial direction, in a cylindrical shape, inserting a central shaft (inner peripheral side piston) in this revolving shaft, driving the revolving shaft by use of a motor, and driving the central shaft in the axial direction by use of an electromagnetostrictive element or the like placed on a stationary side. In this case, by increasing and decreasing a gap between a discharge side end surface of the inner peripheral side piston and its opposite surface, flow rate interruption at the end point and release at the start point can be performed. In short, space in the fluid transport chamber can only be increased and decreased. Moreover, if thread grooves are formed on the outer peripheral side piston and a relative displacement surface located on the stationary side where this outer peripheral side piston is accommodated, there can be provided a fluid pressure-feed mechanism or device similarly to the second embodiment.

When an obstacle (for example, wall) exists in the peripheral portion (63 in FIG. 2) of the PDP substrate 61 of the display panel, it is proper to make the discharge nozzle 33 have a long total length within a range in which a main body of the dispenser and the obstacle do not come into contact with each other.

Moreover, the thread groove pump, which is a fluid pressure-feed mechanism or device, is not always necessary in putting the present invention into practice. It is acceptable to supply a fluid into the pump chamber 31 by utilizing a pressure source (pump or air pressure) installed exteriorly. In this case, it is not required to form a thread groove on the piston. For example, when the U-turn interval can be set sufficiently short with air pressure utilized for the fluid pressure-feed mechanism or device it is proper to control flow rate interruption and release at the start and end points by driving only the piston.

A third embodiment of the present invention will be described below with reference to FIGS. 12 through 16. The third embodiment conversely takes advantage of a constraint condition of mass production that only an extremely short time is accepted as a time until restart of coating after an end of continuous discharge, i.e., a time given to a run of the dispenser in the non-display area (U-turn interval) during a process of coating the PDP substrate 61 of the display panel. That is, by combining this micro dispenser (tentative name) that has this “flow rate control mechanism or device effective only during a short finite time” with a “fluid pressure generating source” installed exteriorly, the aforementioned issues at the start and end portions of the dispenser coating system are solved with an extremely simple construction.

FIG. 12 shows a frontal sectional view of a micro dispenser 200 to which the third embodiment of the present invention is applied. Reference numeral 201 denotes a direct-acting actuator, which is constructed of an electromagnetostrictive type actuator of a giant-magnetostrictive element or the like, an electrostatic type actuator, an electromagnetic solenoid, or the like. In the third embodiment, a giant-magnetostrictive element, which obtained a high positioning accuracy, possessed a high response, and obtained a great generated load, is employed.

Reference numeral 202 denotes a piston driven by first actuator 201, 203 denotes a fixed sleeve that accommodates this piston 202 at a discharge side end portion, 204 denotes a housing that houses the actuator 201, and 205 denotes a lower housing that fixes the fixed sleeve 203 on a discharge side. Reference numeral 206 denotes a cylindrical giant-magnetostrictive rod constructed of a giant-magnetostrictive material, and this giant-magnetostrictive rod 206 is fixed between an upper yoke 209 and the fixed sleeve 203, that concurrently serves as a yoke member, while being interposed between first and second bias permanent magnets 207 and 208 located on upper and lower sides. Reference numeral 210 denotes a magnetic field coil for providing a magnetic field in a lengthwise direction of the giant-magnetostrictive rod 206, and 211 denotes a cylindrical yoke housed in the housing 204. A closed-loop magnetic circuit for controlling extension and retraction of the giant-magnetostrictive rod 206 is formed through a loop of the giant-magnetostrictive rod 206→the first bias permanent magnet 207→the upper yoke 209→the yoke 211→the fixed sleeve 203→the second bias permanent magnet 208→the giant-magnetostrictive rod 206. That is, members 206 through 211 constitute a giant-magnetostrictive actuator 1, which can control an amount of extension and retraction in an axial direction of the giant-magnetostrictive rod by an electric current applied to the magnetic field coil. The piston 202 also extends upwardly while being integrated with cylindrical upper yoke 209 and is accommodated in an upper sleeve 212. The piston 202 is supported by a bearing portion 213 in this upper sleeve 212 so as to be movable in the axial direction. A bias spring 214, which applies a mechanical pre-load in the axial direction to the giant-magnetostrictive rod 206, is provided between the upper sleeve 212 and the upper yoke 209. A displacement sensor 215, which detects an end surface position of the piston 202, is adjustably arranged in a central portion of an upper end of the upper sleeve 212. Reference numeral 216 denotes a piston smaller-diameter shaft, which is a small-diameter portion of the piston 202, 217 denotes an inlet port formed in the lower housing 205, 218 denotes a nozzle portion, and 219 denotes a discharge nozzle formed in this nozzle portion 218. A pressurized fluid, which has flowed from the inlet port 217, flows into a fluid reserve chamber 220 constructed of the fixed sleeve 203 and the lower housing 205, further flows through a fluid restricting portion 221 (described later) into the discharge nozzle 219. A flow rate control portion 222 for controlling a discharge flow rate is constructed among a discharge side end surface of the piston smaller-diameter shaft 216 and its opposite surface, and the lower housing 205.

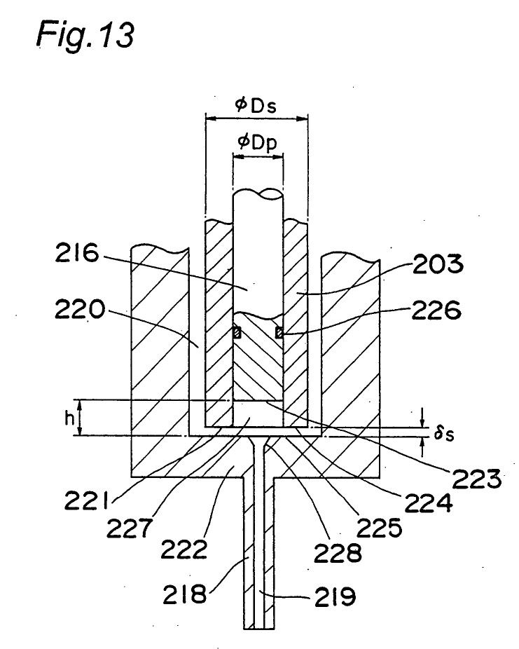

FIG. 13 is an enlarged view of the neighborhood of the flow rate control portion 222 described before, showing a discharge side end surface 223 of the piston smaller-diameter shaft 216 (piston 202), wherein 224 denotes a discharge side end surface of the sleeve 203, and 225 denotes an opposite surface of 223 and 224. Reference numeral 226 denotes a fluid seal provided between the piston smaller-diameter shaft 216 and an inner surface of the fixed sleeve 203. Reference numeral 228 denotes a liquid pool portion formed at an inlet portion of the discharge nozzle. The discharge side end surface 223 of the piston smaller-diameter shaft 216 and its opposite surface 225 constitute a pump chamber 227 (fluid transport chamber) whose volume is changed by ascent and descent of the piston 202.

Analysis for obtaining the discharge flow rate was performed by using the aforementioned Reynolds equation (1) when the fluid control portion 222 is constructed under conditions of following Table 2.

Analytical conditions are fluid viscosity: μ=10,000 cps, modulus of elasticity of volume: K=300 kg/cm2 (29.5 MPa), boundary (peripheral portion of the fluid restricting portion 221) pressure: Ps=20 kg/cm2 (2.06 MPa).

TABLE 2

| Parameters | Symbols | Specifications | |
|---|---|---|---|
| Fixed Sleeve Outside | Ds | 6 | mm |
| Diameter | | | |
| Fixed Sleeve Inside | Dp | 4 | mm |
| Diameter (Piston | | | |
| Smaller-Diameter Shaft | | | |
| Outside Diameter) | | | |
| Gap between Fixed | δs | 30 | μm |
| Sleeve End Surface | | | |
| and Its Opposite | | | |
| Surface | | | |
| Piston Stroke | Xst | 50 | μm |
| Gap between Piston at | Xmin | 100 | μm |
| Lowermost Point and | | | |
| Opposite Surface | | | |
| Piston Operating Time | Tp | 0.05 | sec |
| (Permissible Stop | | | |
| Time) | | | |

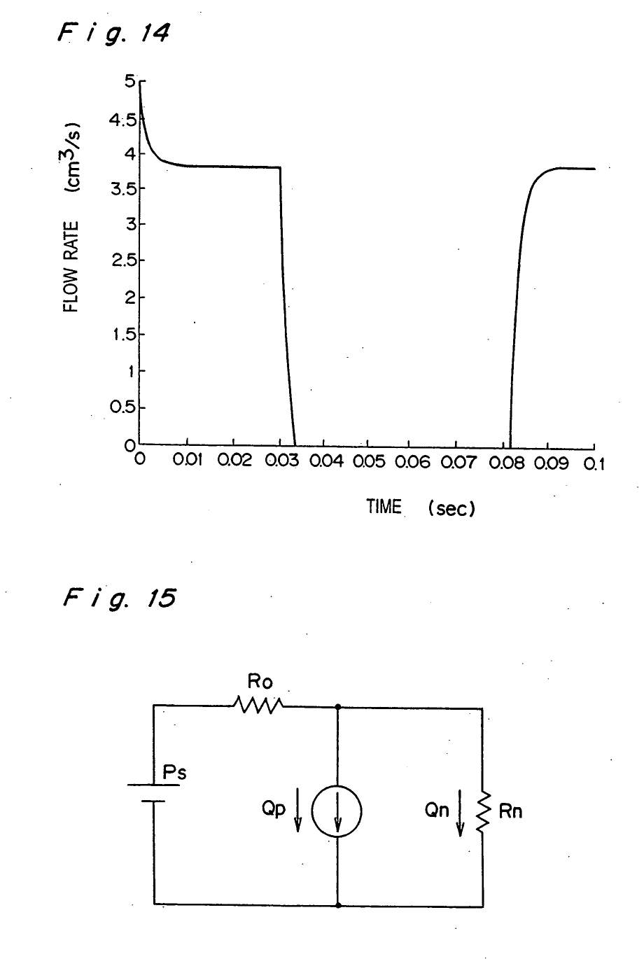

FIG. 14 shows an analytical result of a discharge flow rate obtained under the aforementioned conditions.

(1) In a start stage (t=0) of this analysis, an initial value of the flow rate (pressure) is assumed to have an appropriate value. However, the value promptly settles to a constant value. During the interval 0<t<0.03 sec, there is a continuous drawing state.

(2) If the piston starts moving up when t=0.03 sec, then the discharge flow rate rapidly reduces, and discharge is promptly interrupted within a trailing time of about 0.003 sec (3 msec) from the start.

(3) The discharge flow rate is zero during the interval 0.03<t<0.08 sec. The piston is moving up at a constant velocity during this interval.

According to Table 2, the piston stroke: Xst=50 μm and the piston operating time: Tp=0.05 sec in this embodiment, and therefore, piston ascent time: v=50 μm/0.05 sec=1.0 mm/sec.

(4) If the piston stops when t=0.08 sec, then a continuous coating state is subsequently promptly recovered within a rise time of about 0.01 sec.

From the above-mentioned results, it can be understood that flow rate control of very excellent response on the order of 0.01 seconds or less can be achieved by this embodiment method of steeply increasing an internal space of the discharge passage by using an actuator of excellent response.

It is to be noted that the time during which the discharge flow rate is zero is only when the piston is moving up. This shutoff time is determined by a marginal stroke and an ascending velocity of the actuator.

In the case of an actuator that employs a giant-magnetostrictive element, a displacement of about 10 μm is obtained when an element length is 10 mm. If a piezoelectric element is adopted, displacement is almost halved.

Therefore, if a rod 206 of, for example, a giant-magnetostrictive element of a length of 50 mm is employed in the embodiment of FIG. 12 under the conditions of Table 2, a discharge amount can be turned off while Tp=0.05 sec.

In the above-mentioned analysis, volume of the liquid pool portion 228 is set large, and compressibility of fluid in the liquid pool portion 228 is taken into consideration. However, in the case of an almost incompressible fluid, the aforementioned rise and trailing times can be reduced to a point near a limit of response of the actuator.

In the case of an electromagnetostrictive element such as a giant-magnetostrictive element and a piezoelectric element, a response on the order of 10⁻⁴ sec can be normally obtained.

An actuator of an electromagnetic solenoid or the like is also applicable, and a restriction on stroke (i.e., permissible stop time) is largely alleviated although a response is worsened by about one digit order of magnitude in comparison with the electromagnetostrictive element.

In order to make the principle of the present invention easy to understand intuitively, it is attempted to replace the flow rate control portion 222 of FIG. 13 with an electrical circuit model as shown in FIG. 15.

In FIG. 15, reference character Ps denotes a boundary pressure of the fluid restricting portion 221, R₀ denotes a fluid resistance of the fluid restricting portion 221, Rn denotes a fluid resistance of the discharge nozzle 19, Qp denotes a flow rate source size determined by ascending velocity of the piston smaller-diameter shaft 216 and piston area, and Qn denotes a flow rate of fluid passing through the discharge nozzle 219.

In this case, the flow rate Qn of fluid passing through the discharge nozzle 219 is:

$$Qn = \frac{{P}_{s} - {R}_{0} {Q}_{p}}{{R}_{0} + {R}_{n}} \qquad ( 2 )$$

Discharge is interrupted when Qn<0, i.e., in the following condition.
R₀>Pₛ/Qₚ (3)

According to equation (3), it can be understood that a necessary condition is to provide the fluid restricting portion 221 and make the fluid restricting portion 221 have a fluid resistance R₀ not smaller than a certain value for a purpose of enabling flow rate control. It is proper to provide the portion corresponding to this fluid restricting portion (portion where a passage area is made narrower than other passages) in any portion of the passage extended from the fluid supply source to the flow rate control portion.

If a gap Xmin between the piston located at a lowermost point and the opposite surface is set sufficiently small, then this fluid resistance Rs in a radial direction between the discharge side end surface 224 of the piston and the opposite surface 225 can substitute for the fluid resistance R₀. In this case, the fixed sleeve 203 can be eliminated. However, the fluid resistance Rs has an effective value only when the gap between the piston and its opposite surface is sufficiently small, and equation (3), that is a condition of flow rate interruption in a state in which the piston is elevated high, cannot hold. As a result, a time during which an interruption state can be maintained becomes reduced.

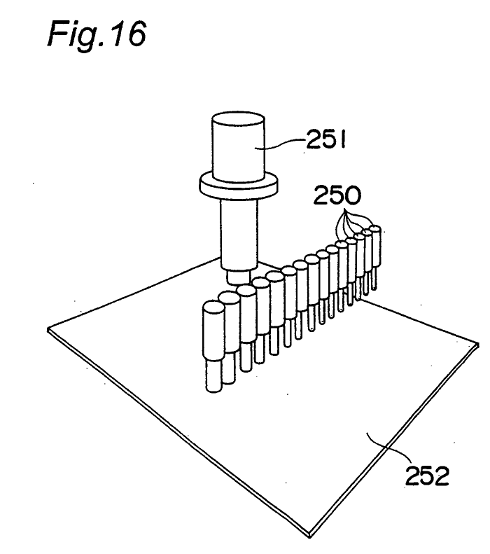

In the third embodiment, issues at the start and end portions of a drawing line are solved by the combination of the dispenser that has the “flow rate control mechanism or device effective only during a short finite time” with the “fluid pressure generating source” installed exteriorly. In order to draw a thousand to several thousands of screen stripes on the display panel with high production efficiency, the number of the dispensers, which can be arranged in the coating apparatus, preferably is as large as possible. In the case of the third embodiment, the dispenser is allowed to have a thin diameter and a simple construction, and therefore, it is easy to provide a multi-head structure as shown in FIG. 16.

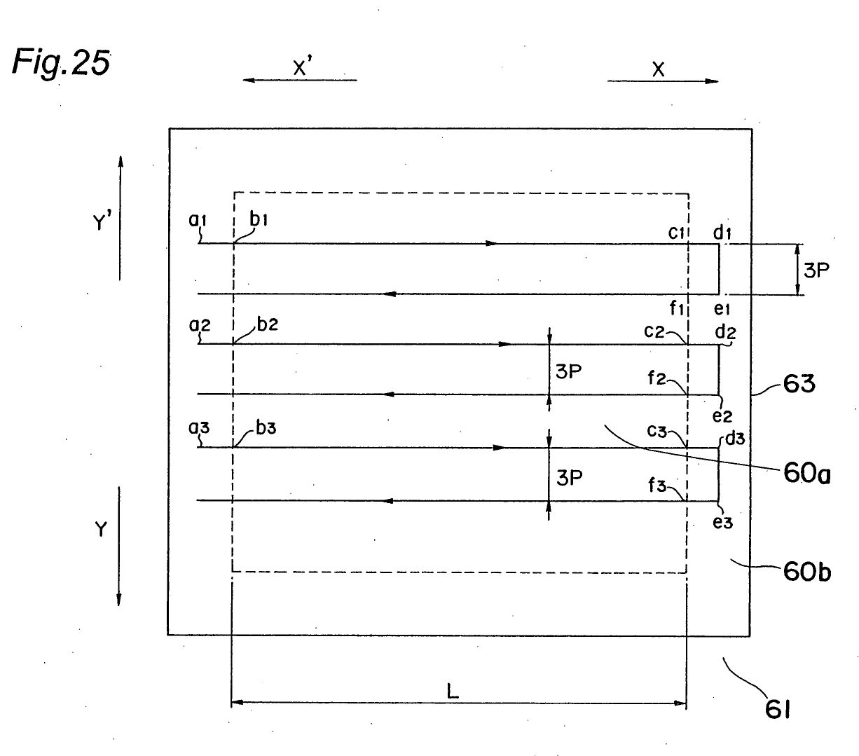

In FIG. 16, reference numeral 250 denotes micro dispensers having the “flow rate control mechanism or device effective only during a short finite time”, 251 denotes a master pump that is a “fluid pressure generating source”, and 252 denotes a glass substrate. The master pump 251 is required to provide the plurality of micro dispensers arranged at a regular pitch with a flow rate supply capability for drawing a plurality of stripe-shaped coating lines and a generated pressure at the same time, as shown in FIG. 25.

FIG. 25 shows an example in which a plurality of fluorescent material paste layers are concurrently discharged and formed on the PDP substrate 61 by the multi-head pattern forming apparatus shown in FIG. 16. In FIG. 25, the preparatory position a, the coating start position b, the coating end position c, the angle position d, the angle position e, the coating start position f, and the coating end position g of the dispenser 55 of FIG. 2 correspond to a preparatory position a₁, a coating start position b₁, a coating end position c₁, an angle position d₁, an angle position e₁, and a coating start position f₁, respectively, of a first micro dispenser, correspond to a preparatory position a₂, a coating start position b₂, a coating end position c₂, an angle position d₂, an angle position e₂, and a coating start position f₂, respectively, of a second micro dispenser, and correspond to a preparatory position a₃, a coating start position b₃, a coating end position c₃, an angle position d₃, an angle position e₃, and a coating start position f₃, respectively, of a third micro dispenser. Then, these three coating lines are concurrently discharged for coating by synchronous movement of these three micro dispensers.

The master pump 251 is not limited to the arrangement of FIG. 16 in which one pump is arranged for a plurality of micro dispensers. It is acceptable to group a plurality of micro dispensers into a group(s) including arbitrary micro dispensers, and arrange groups of micro dispensers and provide one pump for each of the groups or arrange one pump for one micro dispenser.

In the third embodiment, a thread groove pump having a structure similar to that of the first embodiment (see FIG. 3) is employed for this master pump 251. In the case of the thread groove pump, there are features (1) that a powder and granular material (fluorescent material) can be transported from the inlet port to the outlet port mechanically in a non-contact state; (2) that a flow rate can be varied in accordance with a revolution number; (3) that a constant flow rate characteristic can be obtained; (4) that low viscosity can be achieved by providing a shear force by revolution to a fluorescent material of degraded flowability; and so on.

As the master pump, a gear pump, a trochoid pump, a Mono pomp, and the like can be applied to the present invention besides the thread groove pump. Moreover, if the fluorescent material is supplied to the micro dispensers with air pressure utilizing an air source installed exteriorly, instead of the pump, then the coating apparatus in its entirety is remarkably simplified.

Even in the case of the dispenser of the second embodiment that has a “two-degree-of-freedom actuator” of a rotary motion and a rectilinear motion, flow rate control similar to that of the present embodiment can be performed in the U-turn interval if the stroke of the actuator for producing a rectilinear motion can be made sufficiently large. That is, by controlling only the rectilinear motion of the piston with revolution of the motor maintained, discharge interruption and release of fluorescent material paste in the effective display area and the non-effective display area can be controlled. That is, with a revolving state of the motor maintained,

(1) the piston is moved down at the coating start time, and

(2) the piston is moved up at the coating end time.

In this case, in order to satisfy a condition for enabling flow rate control, or a condition that a fluid restricting portion is possessed and a fluid restricting portion has a fluid resistance R₀ not smaller than a certain value, it is proper to utilize an internal resistance possessed by the thread groove pump itself besides a thrust resistance between the piston and its opposite surface. A discharge interruption state can be maintained longer as the thread groove pump has a characteristic closer to a constant flow rate characteristic, and a flow rate is smaller.

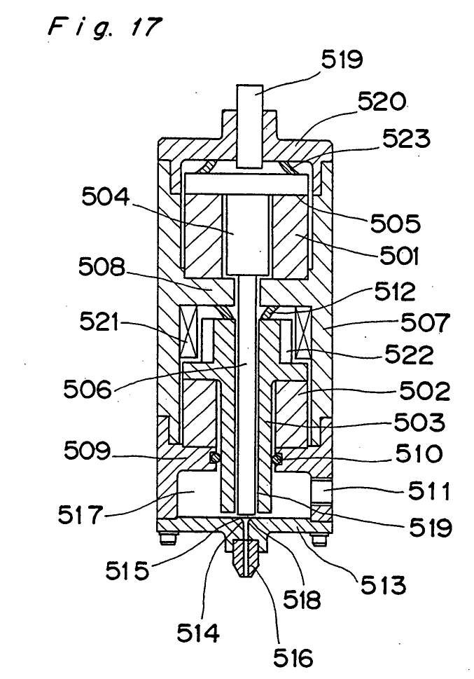

A fourth embodiment of the present invention will be described below with reference to FIGS. 17 through 19. The fourth embodiment is a further improvement of coating start and end portions achieved by providing the piston and the sleeve that accommodates this piston of the third embodiment with a function that they can move in an axial direction. In contrast to a “single piston system” of the third embodiment, a dispenser of the fourth embodiment is referred to as a “double piston system” hereinbelow.

In FIG. 17, reference numeral 501 denotes an upper actuator, 502 denotes a lower actuator, 503 denotes a movable sleeve fixed on a free end side of this lower actuator, 504 denotes a piston fixed on a free end side 505 of the upper actuator, and 506 denotes a smaller-diameter portion of this piston. Reference numeral 507 denotes an upper housing that houses the actuators 501 and 502, and 508 denotes a fixed portion of each piezoelectric element that constitutes the actuators 501 and 502. Reference numeral 509 denotes a lower housing, which is fastened to the upper housing 507. Reference numeral 510 denotes a contact type seal portion mounted between the movable sleeve 503 and the lower housing 509, and 511 denotes an inlet port.

Reference numeral 512 denotes a bias spring for applying an axial bias load to the lower actuator 502, with the spring being mounted between the movable sleeve 503 and the lower housing 507. Reference numeral 513 denotes a lower plate fixed on the lower housing 509, and 514 denotes an opening of an outlet port formed in a position located on a surface opposite to an end surface 515 of the piston smaller-diameter portion 506 in a central portion of this lower plate. Reference numeral 516 denotes a discharge nozzle fastened to the lower plate 513. Reference numeral 517 denotes a fluid reserve portion that utilizes a space formed by the movable sleeve 503 and the lower housing 509, and is connected via the inlet port 511 to a fluid supply source (not shown) arranged exteriorly. Reference numeral 518 denotes a pump chamber (fluid transport chamber), which is a space formed by the movable sleeve 503, the piston smaller-diameter portion 506, and the lower plate 513.

Reference numeral 519 denotes a piston displacement sensor, which is fixed on an upper plate 520 at an upper end of the piston 504 and detects an absolute position of the piston 504 with respect to a stationary side. Reference numeral 521 denotes a stator section of a differential transformer type displacement sensor fixed on an inner surface of the upper housing 507, and 522 denotes a rotor section fixed on the movable sleeve 503. The differential transformer is used for an electric micrometer or the like and detects an axial position of the movable sleeve 503. Reference numeral 523 denotes a bias spring for applying an axial bias load to the upper actuator 501 (piezoelectric element), with the spring being mounted between the piston 504 and the upper plate 520.

In the fourth embodiment, an axial position of the movable sleeve 503 can be accurately detected by the displacement sensor of the differential transformer. This enables control for appropriately matching of an operating timing of the two actuators 501 and 502, and strict control of displacement and velocity of both the actuators.

Moreover, as described in connection with the fourth embodiment, by using a displacement sensor constructed of hollow detection rotor 522 and detection stator 521 for positional detection of the movable sleeve, the dispenser in its entirety can be constructed with cylindrical housings 507 and 509 still having smaller diameters.

The fourth embodiment has a construction in which the two actuators, the two sensors, the piston, and the discharge nozzle are each arranged symmetrically in the axial direction. For example, outer diameters of the giant-magnetostrictive element and the piezoelectric element can be downsized to several millimeters or less, as is well known.

Therefore, if the fourth embodiment, which is the “double piston system”, is used, then a multi-head dispenser combined with a master pump can easily be provided, similarly to the third embodiment.

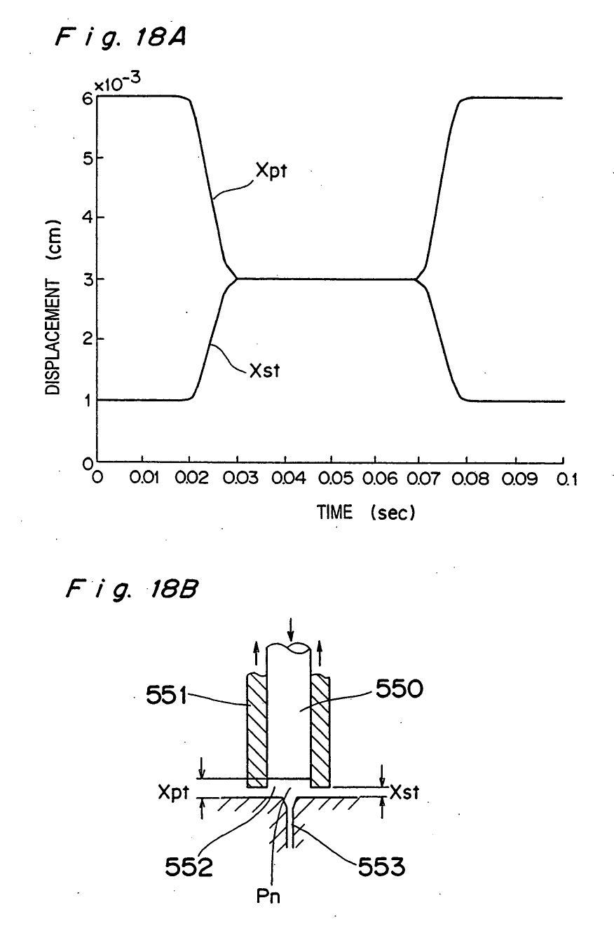

FIG. 18A shows one example of displacement Xp of a piston of a valve with respect to time t and a movable sleeve Xs, to which the fourth embodiment of the present invention is applied. FIG. 18B shows a model diagram of the valve, 550 denotes a piston, 551 denotes a movable sleeve, 552 denotes a pump chamber (fluid transport chamber), and 553 denotes a discharge nozzle.

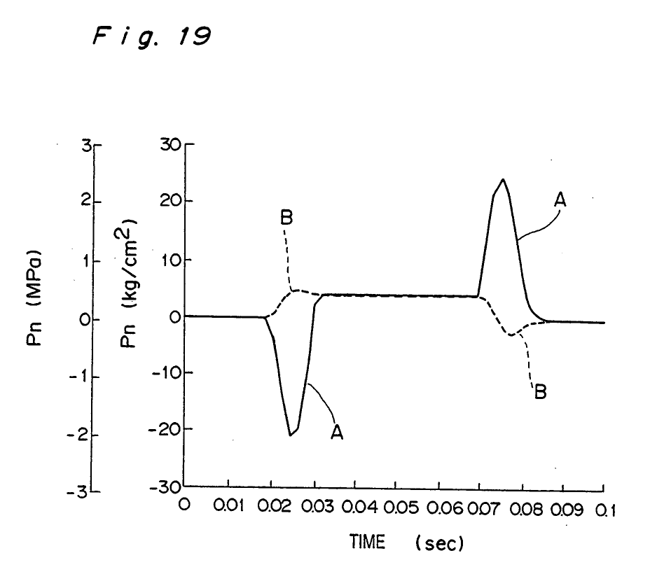

FIG. 19 shows a “pressure Pn characteristic on an upstream side of the discharge nozzle with respect to time” of the valve, to which the fourth embodiment of the present invention is applied, by comparison with a conventional valve. In this case, the conventional valve is shown in the form of a dispenser, which has a needle valve provided in an inlet port portion of a discharge nozzle, and opens and closes an outlet port by moving a spool that constitutes this needle valve in an axial direction. That is, there is shown a structure in which (1) a gap between the piston and an end surface is increased when fluid is released for discharge and (2) the gap between the piston and the end surface is reduced when discharge is interrupted. Therefore, piston operations (1) and (2) become reverse to those of the third embodiment (single piston system).

A pressure P on the upstream side (pump chamber) of the discharge nozzle is largely reduced due to an increase in volume of the pump chamber (not shown), which is the fluid transport chamber, as shown in FIG. 18A, when the gap X between the piston (not shown) and its opposite surface is increased in order to release fluid by using the conventional valve. Negative pressure generated on the upstream side of this discharge nozzle becomes a factor of “incapability of drawing a line at a start point of drawing” or “thinning of the drawing line”.

Further, when the gap X is reduced in order to interrupt the fluid, the pressure P on the upstream side of the discharge nozzle conversely largely increases. This high-pressure generation is due to an effect of dynamic pressure of a fluid bearing, with this effect being called fluid compression or a squeeze action. This high-pressure generation exerts a disadvantageous effect to cause a factor of “generation of liquid pooling” at an end point of drawing.

Using the valve to which the fourth embodiment of the present invention is applied, the piston 550 and the movable sleeve 551 are driven in opposite phase as shown in FIG. 18A.

At this time, axial motions of the piston 550 and the movable sleeve 551 are in opposite phase, and therefore, a change in volume of the pump chamber is canceled. As a result, negative pressure generation at the start time of drawing and high-pressure generation at the end time are reduced as shown by (B) in FIG. 19 to consequently cancel problems of “thinning of the drawing line”, “generation of liquid pooling”, and the like in contrast to (A) of FIG. 19, in which problems such as “thinning of the drawing line”, “generation of liquid pooling”, and the like occur.

If Xpmin is set sufficiently large even when displacement Xp of the piston 550 is Xp=Xpmin when the piston is located in a lowermost position, then an influence of the existence of the piston 550 exerted on passage resistance (i.e., flow rate) can be reduced.

It is acceptable to independently provide drivers for driving the first and second actuators, or drive the actuators in opposite phase by one driver.

Even in the case of the valve in which the discharge side end surface of the piston or the movable sleeve and its opposite surface are not flat surfaces, issues owned by the conventional valve and effects produced by application of the fourth embodiment of the present invention are similar. For example, even if a valve is constructed by making the tip of the piston have a sharp convex surface and making its opposite surface have a concave surface, the present invention can be applied. In this case, fluid is interrupted by putting the convex surface of the piston close to the concave surface of its opposite surface (stationary side). Therefore, dissimilarly to the fourth embodiment of FIG. 17, the fluid is interrupted when the movable sleeve moves up and the piston moves down, and the fluid is released in a reverse case.

In this case, it is proper to provide a setting that Xsmin becomes sufficiently large even if Xs=Xsmin when displacement Xs of the movable sleeve is in a lowermost position.

In any case, it is proper to finely adjust displacement curves of the piston and the movable sleeve according to applied process and characteristics of coating materials in order to draw an optimum drawing line.

In comparison with the “single piston system” of the third embodiment, the advantages of the fourth embodiment, which is the “double piston system”, are as follows.

During a coating release stage and a steady coating stage, the sleeve 551 can be largely moved up simultaneously with descent of the piston 550. The gap: Xs between the sleeve 551 and its opposite surface can be sufficiently large. Therefore, it is not required to provide the passage extended from the inlet port to the discharge nozzle with a great fluid resistance R₀ {equation (3)}, and a sufficient discharge flow rate can be secured.

Moreover, the gap: Xs between the sleeve 551 and its opposite surface can conversely be sufficiently small when coating is interrupted, and therefore, the pump chamber 552 enters a sealed state isolated from an exterior. By moving up the piston 550 in this sealed state, pressure of the pump chamber 552 can be rapidly reduced. This consequently enables achievement of discharge interruption with higher response.

In the dispenser of the fourth embodiment, displacement curves of the piston and the sleeve can be arbitrarily set. Therefore, an overshoot pressure at the start point and a suck-back pressure at the end point can be freely set according to required process conditions. The displacement curves of the piston and the sleeve may not be completely in opposite phase.

Moreover, with a construction in which the sleeve is revolved by a giant-magnetostrictive element as in the second embodiment, it is possible to provide a construction in which continual discharge interruption can be achieved by a dynamic pressure seal.

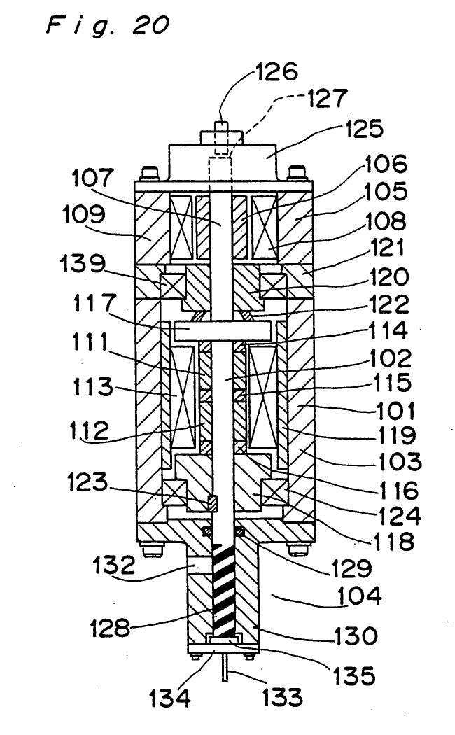

A dispenser applied to a fluorescent material layer forming method and forming apparatus as a fifth embodiment of the present invention will be described below with reference to FIGS. 20 through 22.

The dispenser of the fifth embodiment described below is similar to the second embodiment in that a two-degree-of-freedom actuator, which concurrently gives a rotary motion and a rectilinear motion to the piston, is employed. In the fifth embodiment, a wedge effect by a thrust dynamic pressure seal is utilized as a fluid interruption method instead of using the squeeze effect described in connection with the second through fourth embodiments. The operation is as follows.

(1) Interruption and release of fluid are controlled by forming a thrust dynamic pressure seal between a discharge side end surface of the piston and a relative displacement surface, and adjusting a gap between the piston and the end surface with the piston rectilinearly driven by a first actuator.

(2) A pumping pressure for pressure-feeding coating fluid to the discharge side is generated by revolving the piston, on which a thread groove is formed, by a second actuator that produces a rotary motion.

The above-mentioned operative actions (1) and (2) are concurrently achieved.

In FIG. 20, reference numeral 101 denotes a first actuator, which employs a giant-magnetostrictive element, similarly to the second embodiment. Reference numeral 102 denotes a main shaft (piston) driven by the first actuator 101. The first actuator is housed in a lower housing 103, and a pump portion 104 that accommodates the main shaft 102 is mounted in a lower portion (on a front side) of this lower housing 103.

Reference numeral 105 denotes a second actuator, which produces a relative rotary motion between the main shaft 102 and the housing 103. A motor rotor 106 is fixed on an upper main shaft 107, and a motor stator 108 is housed in an upper housing 109.

Reference numerals 111 and 112 denote a cylindrical rear side giant-magnetostrictive rod and a cylindrical front side giant-magnetostrictive rod, respectively, each of the rods being constructed of a giant-magnetostrictive element. Reference numeral 113 denotes a magnetic field coil for applying a magnetic field in a lengthwise direction of the giant-magnetostrictive rods 111 and 112. Reference numerals 114, 115, and 116 denote permanent magnets provided on a rear side, in an intermediate portion, and on the front side, respectively, for applying a bias magnetic field to the giant-magnetostrictive rods 111 and 112. The permanent magnets 114 and 116 located on the rear side and front side are arranged in a form such that the permanent magnets 114 and 116 hold the giant-magnetostrictive rods 111 and 112 and the intermediate permanent magnet 115 therebetween.

Reference numeral 117 denotes a rear side yoke, which is arranged on the rear side of the giant-magnetostrictive rod 111 and serves as a yoke member of a magnetic circuit. Reference numeral 118 denotes a front side sleeve, which is arranged on the front side of the giant-magnetostrictive rod 112 and concurrently serves as a yoke member. Reference numeral 119 denotes a cylindrical yoke member, which is arranged outside a peripheral portion of the magnetic field coil 113.

That is, the giant-magnetostrictive rods 111 and 112, the magnetic field coil 113, the permanent magnets 114 through 116, the rear side yoke 117, the front side sleeve 118, and the yoke member 119 constitute a giant-magnetostrictive actuator (first actuator 101), which can control extension and retraction in an axial direction of the giant-magnetostrictive rods with an electric current applied to the magnetic field coil.

Reference numeral 120 denotes a rear side sleeve, which accommodates the upper main shaft 7 rotatably and movably in the axial direction. This rear side sleeve 120 is also rotatably supported by a bearing 139 in an intermediate housing 121.

Reference numeral 122 denotes a bias spring, which is mounted between the rear side yoke 117 and the rear side sleeve 120. The giant-magnetostrictive rods 111 and 112 are held by an axial load applied from this bias spring 122 while being pressurized by the rear side yoke 117 and the front side sleeve 118 located on upper and lower sides via the bias permanent magnets 114 through 116. The front side sleeve 118 accommodates the main shaft 2 movably in the axial direction. Rotary power of the main shaft 102 transmitted from the motor 105 is transmitted to the front side sleeve 118 by a revolution transmission key 123 provided between the main shaft 102 and the front side sleeve 118. The front side sleeve 118 is also rotatably supported by a bearing 124 in the housing 103.

Reference numeral 125 denotes an encoder for detecting rotational positional information of the upper main shaft 107, and 126 denotes a displacement sensor for detecting axial displacement of an upper end surface 127 of the upper main shaft 107 (and the main shaft 102).

With the above-mentioned arrangement, a “two-degree-of-freedom complex-motion actuator” such that the main shaft 102 of this device can control rotary motion and rectilinear motion of a very small displacement concurrently and independently, can be provided similarly to the second embodiment.

In the fifth embodiment, a size of the gap at the discharge side end surface of the main shaft 102 can be arbitrarily controlled with a steady revolution state of the main shaft 102 maintained by using an axial direction positioning function of the main shaft 102. By using this function, control of interruption and release of powder and granular material at the start and end portions can be achieved mechanically in a non-contact state in any interval of a passage extended from inlet port 132 to discharge nozzle 133.

That is, when the discharge nozzle 133 of the dispenser and the substrate run relatively to each other in the effective display area 60a (see FIG. 2), the main shaft 102 is in an elevated position, where the gap at the discharge side end surface is sufficiently large, and discharge of the fluorescent material paste is released. Moreover, the main shaft 102 starts moving down before the discharge nozzle 133 and the substrate start running relatively to each other in the non-effective display area 60b (see FIG. 2). As a result, a function of the thrust dynamic pressure seal promptly operates, and discharge of the fluorescent material paste is interrupted.

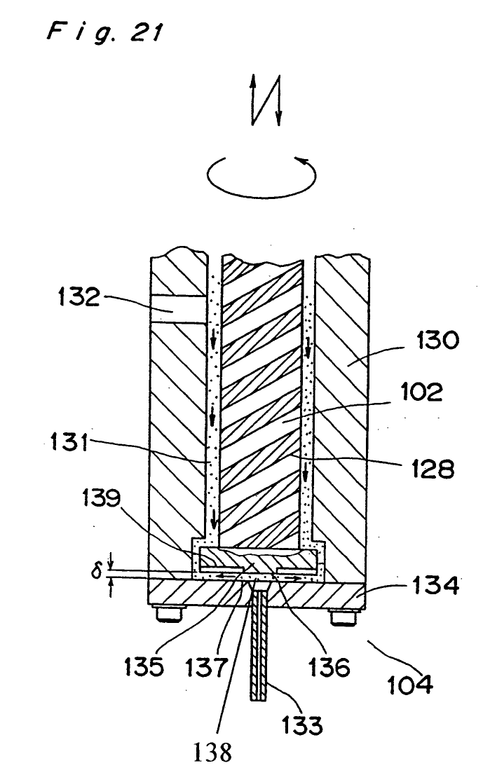

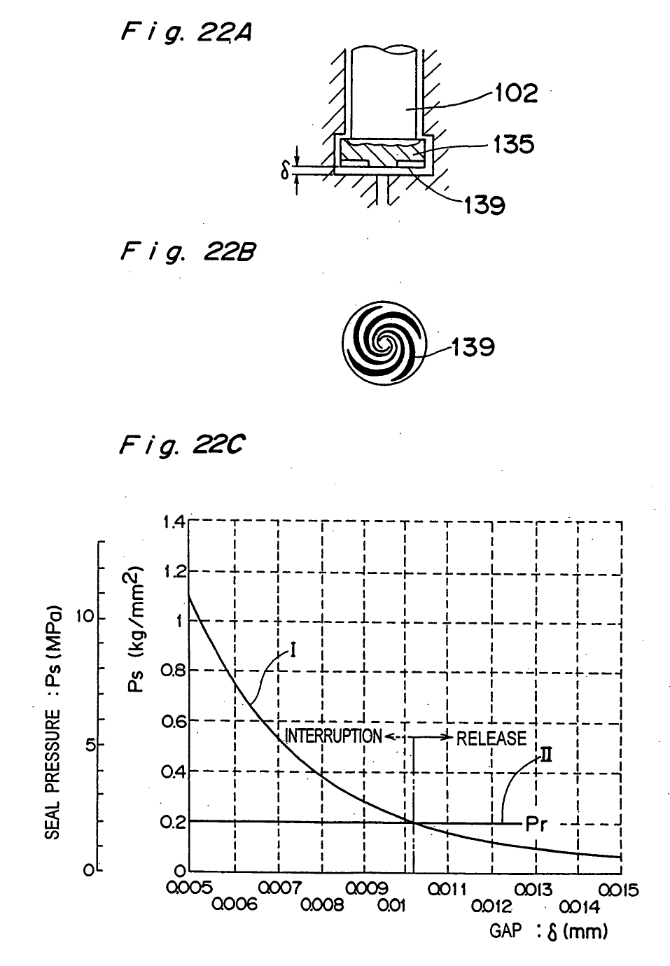

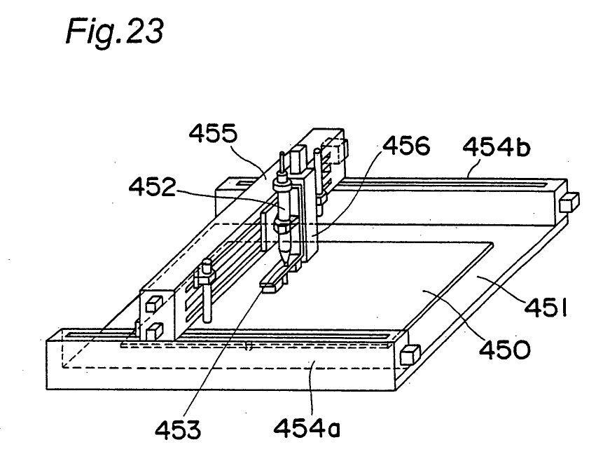

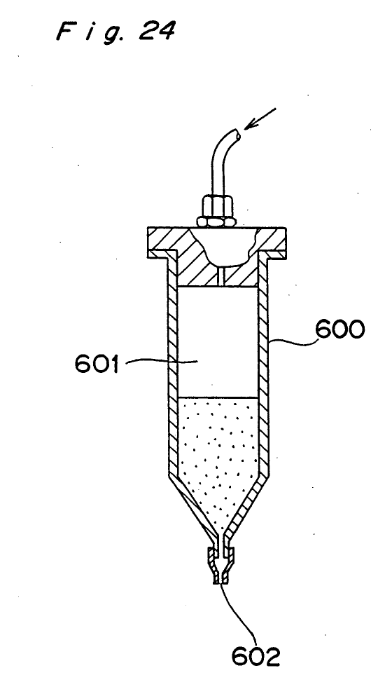

A principle of the thrust dynamic pressure seal will be described below with reference to FIG. 21 that is a detailed view of the pump portion 104, and FIGS. 22A, 22B, and 22C that show relationships between displacement of the dynamic pressure seal and generated pressure.

Reference numeral 128 denotes a radial groove for pressure-feeding fluid, formed on an external surface of the main shaft 102, to the discharge side (the groove portion is painted in black in FIG. 20, and the groove portion is hatched in FIG. 21), and 130 a cylinder. Also, in FIG. 20 reference numeral 129 denotes a fluid seal.

A pump chamber 131 for obtaining a pumping action by revolution of the main shaft relative 102 to the cylinder 130 is formed between this main shaft 102 and the cylinder 130. Moreover, the inlet port 132 communicating with the pump chamber 131 is formed in the cylinder 130. Reference numeral 133 denotes the discharge nozzle attached to the lower end portion of the cylinder 130, and 134 denotes a discharge plate fastened to the discharge side end surface of the cylinder 130. Reference numeral 135 denotes a thrust plate fastened to the discharge side end surface of the main shaft 102. An opening 138 of the discharge nozzle 133 is formed in a central portion of the opposite surface 137 of the discharge side end surface 136 of the main shaft 102.

Moreover, a groove 139 (the groove portion is painted in black in FIG. 22B) of the thrust dynamic pressure seal is formed on the discharge side end surface 136 of the thrust plate 135.

The thrust groove 139 for sealing is well known as a thrust dynamic-pressure bearing.

A seal pressure Ps that the thrust bearing can generate is given by the following equation.

$${P}_{S} = f \frac{ω}{{δ}^{2}} ( {R}_{0}^{4} - {R}_{i}^{4} ) \qquad ( 4 )$$

In equation (4), ω is a rotating angle velocity, R₀ is an outer radius of the thrust bearing, Rᵢ is an inner radius of the thrust bearing, f is a function determined by groove depth, groove angle, groove width, ridge width, and so on.

A curve (I) in the graph of FIG. 22C represents a characteristic of the seal pressure P_{S} with respect to the gap δ when a spiral groove type thrust groove is used under conditions of following Table 3. A curve (II) in the graph of FIG. 22C is one example that represents a relationship between pumping pressure of the radial groove and the gap δ at the shaft tip when there is no axial flow. A pumping pressure of this radial groove can be chosen by selecting the radial gap, groove depth, and groove angle in a wide range, similarly to the aforementioned thrust groove. However, pumping pressure Pr of the radial groove does not qualitatively depend on the size of the gap at the shaft tip (i.e., the size of the gap δ).

When the gap δ of the thrust groove for sealing is sufficiently large or, for example, when the gap δ=15 μm, generated pressure is P=0.06 kg/mm² (0.69 MPa).

The end surface of the main shaft 102 is put close to the opposite surface on the stationary side with the shaft revolving. When the gap δ<10.0 μm, the seal pressure becomes greater than the pumping pressure Pr of the radial groove, and outflow of fluid to the outlet port side is interrupted.

FIG. 21 shows a state in which the outflow of the fluid is interrupted. The fluid in the neighborhood of the opening 138 of the discharge nozzle receives a pumping action (see the arrow in FIG. 21) in a centrifugal direction by the thrust groove 139, and therefore, the neighborhood of the opening 138 comes to have a negative pressure (below atmospheric pressure). By this effect, the fluid, which has been left inside the discharging nozzle 133 after interruption, is sucked again to an interior of the pump. As a result, no fluid mass is formed by surface tension at the discharge nozzle tip, thereby canceling thread-forming and driveling.

The fifth embodiment of the present invention is able to freely control turning on and off a discharge state of the fluid by moving the revolving shaft by about ten to several tens of micrometers in the axial direction.

Summarizing points of the aforementioned embodiment of the present invention, the embodiment is advantageous in that in contrast to the fact that the seal pressure by the thrust groove sharply increases when the gap δ is reduced, the pumping pressure of the radial groove is extremely insensitive to a change in the gap δ.

It is acceptable to form each of the radial groove and the thrust groove on either the rotary side or the stationary side.

Moreover, when coating a powder and granular material such as a fluorescent material or an electrode material including minute particles, it is proper to set the minimum value δmin of the gap δ larger than a very small particle diameter φd.
δmin>φd (5)

In order to obtain a larger gap with respect to same generated pressure, it is proper to increase the revolution number, or increase an outer diameter of the thrust plate 135 and select values appropriate for groove depth, groove angle, and so on.

TABLE 3

| Parameters | | Symbols | Setting Values | |
|---|---|---|---|---|
| Revolution Number | | N | 200 | rpm |
| Viscosity Coefficient | | μ | 10000 | cps |
| of Fluid | | | | |
| Thrust Groove | Groove Depth | hg | 10 | μm |
| for | Radius | r₀ | 3.0 | mm |
| Sealing | | rᵢ | 1.5 | mm |
| | Groove Angle | α | 30 | deg |
| | Groove Width | bg | 1.5 | mm |
| | Ridge Width | br | 0.5 | mm |

In the fifth embodiment, the thread groove pump is employed as the pressure source for supplying the fluorescent material paste to the discharge portion where the thrust dynamic pressure seal is formed. It is acceptable to employ a pump installed exteriorly as the pressure source of this coating fluid in place of this thread groove pump. Otherwise, an air pressure regularly provided in a factory is acceptable. In short, it is proper to set the supply pressure of the pressure source under a maximum seal pressure that the thrust dynamic pressure seal can generate.

Hereinafter, it is surmised that an extremely great fluid pressure is generated for both the pumping pressure and the squeeze pressure when a high-viscosity fluid is discharged in any of the first through fifth embodiments. In this case, the first actuator that drives the piston is required to generate a great thrust force against a high fluid pressure, and therefore, application of an electromagnetostrictive type actuator capable of easily generating a power of several hundred to several thousand Newton is effective. Since the electromagnetostrictive element has a frequency responsibility of not lower than several Megahertz, the electromagnetostrictive element can make the main shaft rectilinearly move with high responsability. Therefore, a discharge amount of the high-viscosity fluid can be controlled with high response and high accuracy.

Moreover, when the giant-magnetostrictive element is used as an axial driving mechanism or device, a conductive brush can also be eliminated in comparison with the case of the piezoelectric element used. Therefore, a load of the motor (revolution mechanism or device) can be reduced, and an overall construction becomes extremely simplified. Therefore, a moment of inertia of movable parts can be reduced as far as possible, and a diameter of the dispenser can be reduced.

Embodiments in which fluorescent material is coated onto a backplate as a PDP substrate is described above. However, the present invention can also be applied to formation of electrodes on a faceplate as a PDP substrate, according to another embodiment.

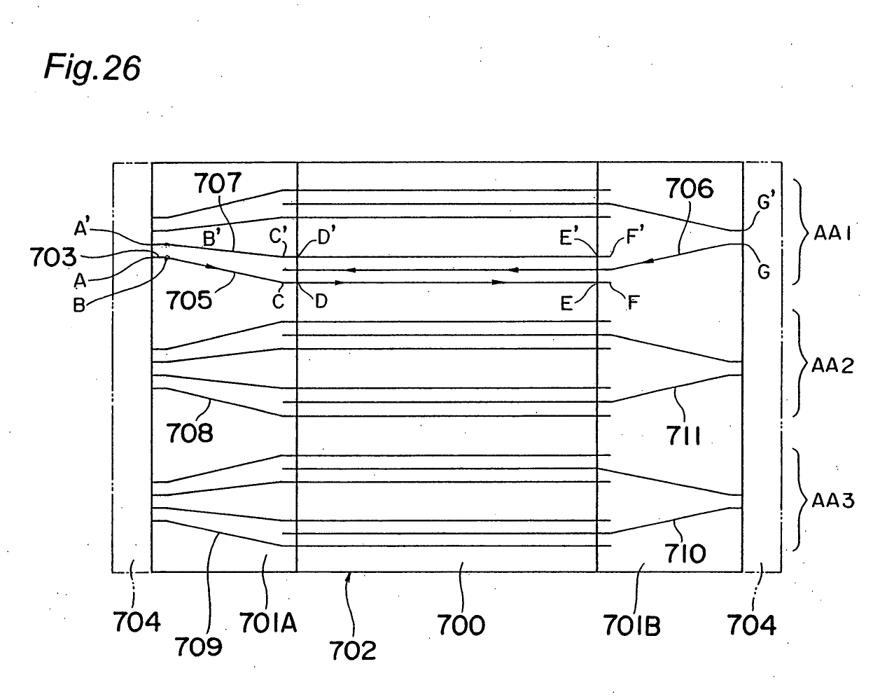

FIG. 26 shows another example of a PDP faceplate, where reference numeral 700 denotes an “effective display area” (bus electrode portion) corresponding to an effective display area of the PDP, which is an area serving as the counterpart of the above-described effective display area 60a (see FIG. 2) of the backplate on which the fluorescent material is coated. Reference numerals 701A and 701B denote terminal portions, which are each referred to as a “semi-effective display area”. The effective display area 700, the terminal portion 701A, and the terminal portion 701B constitute a PDP faceplate 702 constructed of a glass substrate. Reference numeral 703 denotes a tab junction.

Reference numeral 704 denotes a virtual area for paste coating provided on both side portions (right and left side portions in FIG. 26) outside the faceplate 702, with this virtual area being referred to as a “non-effective display area”.

For example, an electrode line 705, which has a start point (coating start position) A (or an end position (coating end position)) at a left-hand side end portion on the faceplate, is constructed of: the tab junction 703, which is located inside the semi-effective display area 701A and extended from the coating start position A to an angle position B; an inclined portion, which is located inside the semi-effective display area 701A and extended from the angle position B to an angle position C; an effective display boundary neighborhood portion, which is located inside the semi-effective display area 701A and extended from the angle position C to an effective display boundary position D; an effective display linear portion, which is located inside the effective display area 700 and extended from the effective display boundary position D to an effective display boundary position E; and an end neighborhood linear portion, which is located inside the semi-effective display area 701A and extended from the effective display boundary position E to a coating end position F. Therefore, the electrode line 705 passes through the semi-effective display area 701A and enters the effective display area 700 in the effective display boundary position D. Further, the electrode line 705, which has passed through the effective display area 700, enters the right-hand side semi-effective display area 701B in the effective display boundary position E and stops in the coating end position F immediately thereafter. That is, the coating end position F inside the semi-effective display area 701B becomes an end position (coating end position) (or start position (coating start position)) of the electrode line 705. Other electrode lines 708, 709, and 707 have utterly same construction. Further, other electrode lines 706, 711, and 710 have basically same construction except that these lines are laterally reversed with the coating start position serving as the start position (coating start position) G in the right-hand side end portion of the faceplate. Therefore, inclined portions of the electrode lines 706, 711, and 710 have same angle of inclination, while inclined portions of the electrode lines 705, 708, 709, and 707 have same angle of inclination.

The electrode line 706 located adjacent to the electrode line 705 is formed laterally reversely to the electrode line 705 with regard to a start position and end position. The electrode line 707 located adjacent to the electrode line 706 is formed laterally reversely to the electrode line 706 with regard to a start position and end position. As described above, in the PDP of this embodiment, the electrode lines, which have the stop positions in the right-hand and left-hand semi-effective display areas, are formed so as to alternately change places.

A concrete example (I) of a coating method will be described first. In the present embodiment intended for formation of electrodes on the faceplate of a PDP, a method similar to the second embodiment is applied. That is, a dispenser that has a “two-degree-of-freedom actuator” is used to operate as follows.

(1) Positive and negative squeeze pressures are generated on a discharge side end surface of a piston by rectilinearly driving the piston by a first actuator.

(2) A pumping pressure is generated by revolving the piston on which a thread groove is formed by a second actuator that produces a rotary motion, and a coating fluid is pressure-fed to the discharge side.

By combining the above-mentioned operative actions (1) and (2) with each other, there are achieved:

(1) continuous line coating in the effective display area;

(2) control of interruption and release of the coating line in boundary portions of the effective display area and the non-effective display area; and

(3) control of interruption and release of the coating line in the semi-effective display area.

Paying attention to the electrode line 705, the case of coating a silver paste, which is an electrode material, will be described below.

(i) At a Coating Start Time

In a state before starting coating, a tip of the discharge nozzle 33 (see FIG. 6 of the second embodiment) is in the non-effective display area 701 A. At this time, the revolution of the motor is stopped, and the piston (main shaft 2) is in an elevated position. The dispenser starts running downward in FIG. 26 from the coating start position A′ of the electrode line 707 inside the non-effective display area 704, and thereafter, the piston is moved down simultaneously with revolving of the motor in accordance with a timing immediately before passing through the coating start position A. As already described, in order to smoothly draw the coating line in the coating start position A, an overshoot pressure is larger as a stroke of the piston is larger and a rise time is shorter. That is, it is proper to set a magnitude of this overshoot pressure so that surface tension of fluid at the discharge nozzle tip is overcome within a range in which “fattening” of the coating line does not occur in the coating start position A.

(ii) Run in the Semi-Effective Display Area

The piston coats a continuous line from the coating start position A via the angle position B and the angle position C to the effective display boundary position D by constant rate discharge via the pumping pressure of the thread groove while maintaining the gap between the piston and its opposite surface constant. In this interval, no squeeze pressure is generated. In the embodiment, a line width of the electrode line 705 inside the semi-effective display area 701A was, for example, b₂=0.1 mm, which was greater than the line width: b₁=0.075 mm inside the effective display area 700. Therefore, when the discharge nozzle runs through the semi-effective display areas 701A and 701B, coating is performed with the thread groove revolution number made higher than when the nozzle is running in the effective display area 700.

(iii) Running in the Effective Display Area

In the interval from the effective display boundary position D to the effective display boundary position E, the piston performs coating with the thread groove revolution number made lower than in the above case (ii) so as to maintain a line width: b₁=0.075 mm while maintaining the gap between the piston and its opposite surface constant.

(iv) Run and Interruption in the Semi-Effective Display Area

A coating condition up to the coating end position F after passing through the effective display boundary position E is similar to that of (ii). The piston is quickly moved up simultaneously with stopping the motor in accordance with the timing immediately before reaching the coating end position F. At this time, discharge is momentarily interrupted by an effect of negative pressure generated when (dh/dt)>0 on an assumption that h is the gap between the mutually opposite surfaces and t is time. Subsequently, the discharge nozzle tip promptly shifts from the coating end position F to a position G′ at the right-hand end of the non-effective display area 704 located in a shortest distance maintaining a discharge interruption state, and starts coating with the position G serving as the start position.

Continuous lines are repeatedly coated by a method similar to the method of (i) through (iv).

By the method described above, time loss in making the discharge nozzle 33 run relatively to the X-Y stage that positions and holds the faceplate can be reduced as far as possible, and thus efficient coating can be performed.

In the aforementioned process (iv), discharge is interrupted by moving up the piston inside the semi-effective display areas 701A and 701B. By this method, the coating end position F of the drawing line can be formed in accordance with reliable timing and with extremely high quality. That is, neither “fattening” nor “pooling stagnation” of the drawing line occurs in the coating end position F. If “fattening” or “stagnation” is significantly generated, serious influence is disadvantageously exerted on an electrical characteristic between mutually adjoining electrode lines. There is also a method for drawing a drawing line with the coating end position F conversely served as the start position, with the method being somewhat delicate in comparison with a case where an optimum overshoot pressure setting method is terminal control. Setting of line width in the effective display area 700 and line width in the semi-effective display areas 701A and 701B may be achieved by adjusting a velocity of the discharge nozzle relative to the stage besides the thread groove revolution number.

Next, there will be described a case of coating electrode lines by multiple heads as a concrete example (II) of the coating method. As a multi-head system, there may be, for example, a construction of a combination of one master pump and a plurality of micro-pumps, as shown in FIG. 16.

In the semi-effective display areas 701A and 701B, there are varied angles of inclination of the electrode lines. Therefore, it is difficult for the multiple heads arranged at a parallel pitch to concurrently coat a plurality of electrode lines inside the semi-effective display area. Therefore, coating was performed by the following method.

When the electrode line 705 is drawn in step SI, coating starts from a start point located in the position C inside the semi-effective display area 701A, passes through the effective display area 700 and ends in the position F inside the semi-effective display area 701B. At this time, simultaneously, coating of another electrode line (707, for example), which has the same pattern, by a head arranged at a parallel pitch starts from a start point located in a position C′ and ends in a position F′. Coating is performed by making the multi-head in its entirety run from the left-hand side to the right-hand side, and thereafter making the entire head run from the right-hand side to the left-hand side in a next stage. By this repetitive operation, coating of the electrode lines constructed of a plurality of parallel lines is completed.

Next, the method proceeds to coating at step S2. When electrode lines of varied angles of inclination are drawn inside the semi-effective display areas 701A and 701B by the multiple heads, the following method is used. Assuming that groups of electrode lines constructed of electrode lines of varied angles of inclination inside the semi-effective display areas 701A and 701B are AA₁ through AAₙ (see FIG. 26, n is the total number of the group), then a plurality of sets of the groups are formed on the PDP faceplate. Accordingly, the electrode lines, which have the same angle of inclination, are selected from the plurality of groups AA₁ through AAₙ, and this group is assumed to be BB. The group BB is constructed of, for example, the electrode lines 705, 708, and 709. The electrode lines of group BB can be concurrently coated if the nozzle is relatively moved in the X-Y directions relative to the X-Y stage that holds the PDP faceplate.

There is described above a case where the process (step S1) for drawing the electrode lines of a plurality of parallel lines inside the effective display area and the process (step S2) for drawing the electrode lines of the same angle of inclination inside the semi-effective display area are separately performed by using the multiple heads.

The coating of the plurality of electrode lines inside the effective display area (step S1) becomes advantageous in terms of production cycle time as the number of heads is greater since an electrode line length is long.

The coating of the electrode lines inside the semi-effective display area (step S2) is to select only the heads (n=3 in FIG. 26) in proper positions from the multiple heads and use the same for the coating. In this case, repetition frequency of coating increases in comparison with step S1. However, since the electrode line length is short in the semi-effective display area, there is no significant delay in cycle time. According to the method of coating inside the semi-effective display area, there is needed high-quality coating at both “start ends” and “terminal ends” of the coating lines. If the multiple heads are constructed by combining one master pump with a plurality of micro-pumps, and the “double piston system”, which is described in connection with the fourth embodiment, is used for these micro-pumps, then both the start and end portions of the drawing lines can be drawn with high quality.

Further, there will be described a case of drawing electrode lines located inside the effective display area 700 and the semi-effective display areas 701A and 701B by multiple heads in a stroke as a concrete example (III) of the coating method. In this case, a drawing line is required to be controlled only at, for example, a “terminal end”, and a number of the multiple heads is allowed to be the number of the groups AA₁ through AAₙ (n=3 in FIG. 26). As a multi-head system configuration, there may be, for example, a construction of a combination of one master pump and a plurality of micro-pumps, as shown in FIG. 16. Each micro-pump can adopt a simple structure if the method of controlling the start and end portions of the drawing line by utilizing generation of a negative pressure and a positive pressure in accordance with ascent and descent of a piston is used. Otherwise, it is acceptable to arrange a plurality of dispensers that have the two-degree-of-freedom actuators described in connection with the aforementioned concrete example (I).

In concrete, in FIG. 26, for example, the electrode lines 705, 708, and 709 are selected as electrode lines that have same angle of inclination. An interval between the nozzles of the heads is preparatorily determined according to a coating pattern of an electrode layer. Since a method similar to the concrete example (I) can be adopted as a method for coating of subsequent heads, no detailed description is provided therefor.

Moreover, as another example in which the dispenser runs relatively to the substrate, a mechanism for moving the X-Y stage in orthogonal X-Y directions in a state in which dispenser 304 is attached to stationary frame 303 as shown in FIG. 27 will be described. A mechanism for moving the X-Y stage in the orthogonal X-Y directions in the state in which the dispenser 304 is attached to the stationary frame 303 while being able to vertically move only in a Z-axis direction by a Z-axis motor 302 will be described. For this mechanism, a Y-axis table 307 advances and retreats in the X-direction by driving an X-axis motor 300 fixed on a stationary frame side. A substrate placement table 305 on which a substrate 306 is positioned and held advances and retreats in the Y-direction by driving the Y-axis motor 301 fixed on a Y-axis table 307.

With this arrangement, a run of the dispenser 304 relatively to the substrate can be achieved by moving the substrate placement table 305 in each of the X-Y directions with the dispenser moved up and down only in the Z-axis direction by the Z-axis motor 302.

In the above-mentioned embodiment, it is acceptable to: stop discharge or stop discharge after reduction, by reducing and thereafter stopping the revolution number of the revolving shaft of the thread groove type dispenser when the dispenser and the substrate relatively shift from the effective display area to the non-effective display area; and stop discharge further lifting the paste by about 10 μm with the revolving shaft reversely revolved for, for example, 10 msec or less.

Instead of this, it is also acceptable to perform discharge with the revolution number of the revolving shaft maintained constant after increasing the revolution number of the revolving shaft of the thread groove type dispenser, or perform the discharge with the revolution number of the revolving shaft maintained constant after increasing and then decreasing the revolution number of the revolving shaft, when the dispenser and the substrate relatively shift from the non-effective display area to the effective display area.

Further, in the above-mentioned embodiment, when a plurality of thread groove type dispensers are arranged, it is also possible to individually adjust the revolution number of the plurality of thread groove type dispensers to set a prescribed flow rate.

In the aforementioned various embodiments, the giant-magnetostrictive actuator is employed for the device that drives the piston in the axial direction. However, if there is no need for forming the start and end portions of the drawing line with such high quality, it is acceptable to employ a linear motor, an electromagnetic solenoid, or the like, in place of the giant-magnetostrictive actuator, although responsability is reduced.

The embodiments of the continuous coating for drawing a continuous line on a display panel have been described above. However, the present invention can also be applied to intermittent coating. Also, in this case, a scheme of start and end control at coating start and end times can be applied. Otherwise, the scheme can be applied to coating such that a pseudo-continuous line is formed by connecting adjoining fluid masses with each other by natural flow by virtue of super-high-speed intermittent coating.

By properly combining arbitrary embodiments of the aforementioned various embodiments, effects owned by each of them can be made effectual.

According to the method and apparatus of forming a pattern of a display panel of the present invention, for example, a fluorescent material layer, an electrode layer, and the like can be accurately formed on a substrate of an arbitrary size merely by a numerical value setting of, for example, substrate specifications without using a conventional screen mask, and this arrangement can easily cope with a change in specifications of the substrate. Moreover, the arrangement, which can cope with a high-speed process, therefore has no inferiority in terms of production cycle time in comparison with the conventional processing method and is able to remarkably reduce material loss since there is no material to be scrapped.

There is no need for increasing a scale of both a manufacturing process and production line, and it is enabled to perform screening with a single apparatus. Moreover, display panels of wide-variety and low-volume production can be manufactured with improved mass production effects, and an automated line can be operated with a small-scale machine by virtue of screening with a single apparatus. The effects are tremendous.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A display panel pattern forming method for forming a paste layer of a certain pattern by discharging a paste while relatively moving a dispenser (55) of a variable flow rate to a substrate (61) so as to successively discharge the paste in a position that belongs to the substrate and is to receive the paste discharged, the method comprising of:
discharging the paste when the dispenser is running relatively to an effective display area of the substrate that has the effective display area (60a, 700) in which the paste layer is formed and a non-effective display area (60b, 701A, 701B) which is located outside the effective display area and in which the paste layer is not formed; and interrupting the discharge of the paste when the dispenser is running relatively to the non-effective display area.

2. The display panel pattern forming method as claimed in claim 1, for forming the paste layer of the certain pattern by discharging the paste while moving the dispenser relatively to the substrate on a surface of which a plurality of photoabsorption layers are formed parallel to one another so as to successively discharge the paste in a position that is located between the photoabsorption layers and is to receive the paste discharged, wherein the discharge of the paste is controlled by using a dispenser of a variable flow rate as the dispenser.

3. The display panel pattern forming method as claimed in claim 2, wherein a discharge amount of the paste is varied by controlling the dispenser in accordance with a relative velocity between the dispenser and the substrate.

4. The display panel pattern forming method as claimed in claim 2, wherein the paste is discharged when the dispenser is running relatively to the effective display area of the substrate that has the effective display area (60a) in which the paste layer is formed and the non-effective display area (60b) which is located outside the effective display area and in which the paste layer is not formed; and the discharge of the paste is interrupted when the dispenser is running relatively to the non-effective display area.

5. The display panel pattern forming method as claimed in claim 2, wherein a thread groove type dispenser is employed as the dispenser, and the discharge of the paste is controlled by revolution control of a revolving shaft of the thread groove type dispenser.

6. The display panel pattern forming method as claimed in claim 4, wherein a thread groove type dispenser is employed as the dispenser, and when the dispenser and the substrate run relatively to the non-effective display area, the revolution of the revolving shaft of the thread groove type dispenser is stopped or the revolving shaft is revolved reversely to the run through the effective display area.

7. The display panel pattern forming method as claimed in claim 5, wherein, when the dispenser and the substrate relatively shift from the effective display area to the non-effective display area, the discharge is stopped by reducing and thereafter stopping a revolution number of the revolving shaft of the thread groove type dispenser or the discharge is stopped by stopping after being reduced and then reversing the revolution of the revolving shaft.

8. The display panel pattern forming method as claimed in claim 5, wherein, when the dispenser and the substrate relatively shift from the non-effective display area to the effective display area, the discharge is effected by increasing a revolution number of the revolving shaft of the thread groove type dispenser and thereafter maintaining constant the revolution of the revolving shaft or the discharge is effected by increasing and thereafter reducing the revolution number and thereafter maintaining constant the revolution of the revolving shaft.

9. The display panel pattern forming method as claimed in claim 5, wherein a plurality of thread groove type dispensers are employed as the dispenser, and prescribed flow rates are set by individually adjusting revolution numbers of the plurality of thread groove type dispensers.

10. The display panel pattern forming method as claimed in claim 2, wherein the dispenser supplies the paste to a fluid transport chamber that serves as a paste pressure-feed device and is formed of a cylinder and a piston and varies a discharge amount of the paste by increasing and decreasing a space of the fluid transport chamber with a relative axial motion given to the cylinder and the piston.

11. The display panel pattern forming method as claimed in claim 10, wherein the paste is pressure-fed by giving a relative rotary motion to a thread groove formed on a relative displacement surface of the cylinder and the piston.

12. The display panel pattern forming method as claimed in claim 10, wherein, when a tip of the nozzle and the substrate relatively shift from the effective display area to the non-effective display area, the discharge of the paste is stopped by increasing the space of the fluid transport chamber.

13. The display panel pattern forming method as claimed in claim 10, wherein, when a tip of the nozzle and the substrate relatively shift from the non-effective display area to the effective display area, the paste is discharged by reducing the space of the fluid transport chamber formed of the cylinder and the piston.

14. The display panel pattern forming method as claimed in claim 10, wherein, when a tip of the nozzle and the substrate run relatively to the non-effective display area, the discharge of the paste continues being stopped by increasing the space of the fluid transport chamber formed of the cylinder and the piston.

15. The display panel pattern forming method as claimed in claim 2, wherein the dispenser pressure-feeds the paste to a fluid transport chamber that serves as a paste pressure-feed device and is formed of a cylinder, a piston, and a sleeve that accommodates at least part of this piston and varies the discharge of the paste by increasing and decreasing a space of the fluid transport chamber with a relative axial motion given to the cylinder and the piston and to the piston and the sleeve.

16. The display panel pattern forming method as claimed in claim 15, wherein discharge of the paste is started or stopped by making a relative displacement curve of the cylinder to the piston and a relative displacement curve of the piston to the cylinder have an approximately opposed phase or a reversed movement direction.

17. The display panel pattern forming method as claimed in claim 2, wherein the variable flow rate dispenser performs discharge flow rate control of the paste by increasing and decreasing a fluid resistance of the paste with a gap of a passage between the shaft and the housing changed by driving the shaft relatively to the housing in an axial direction.

18. The display panel pattern forming method as claimed in claim 17, wherein the dispenser discharges the paste by generating a pumping pressure for pressure-feeding the paste from an inlet port to an outlet port of the housing with the shaft revolved relatively to the housing.

19. The display panel pattern forming method as claimed in claim 17, wherein outflow of the paste is interrupted by a dynamic pressure seal formed on a relative displacement surface of the shaft and the housing.

20. The display panel pattern forming method as claimed in claim 19, wherein the dispenser performs flow rate control of the paste by increasing and decreasing a fluid resistance of the paste with the gap of the passage where the dynamic pressure seal is formed between the shaft and the housing changed by revolving the shaft relatively to the housing and moving the shaft relatively to the housing in the axial direction.

21. A display panel pattern forming apparatus for forming a paste layer of a certain pattern by discharging a paste between a plurality of photoabsorption layers provided parallel to one another on a surface of a substrate, the apparatus comprising:
a baseplate for placing the substrate thereon;
a dispenser having at least one nozzle for discharging the paste;
a transport unit for moving the nozzle relatively to the baseplate; and
a control unit for controlling the transport section and the dispenser so that the paste is successively discharged in prescribed positions between the photoabsorption layers,
the dispenser being a thread groove type.

22. The display panel pattern forming apparatus as claimed in claim 21, wherein
the dispenser comprises:
a cylinder which has an inlet port and an outlet port of the paste and in which a fluid transport chamber is formed;
a piston accommodated in the cylinder; and
an actuator for giving a relative motion to the cylinder and the piston in order to increase and decrease an internal space formed of the cylinder and the piston,
the apparatus being constructed so that the paste, which has flowed into the fluid transport chamber from the inlet port, flows out via a passage connected to the internal space to the outlet port.

23. The display panel pattern forming apparatus as claimed in claim 21, wherein in place of the thread groove type dispenser, the dispenser comprises:
a first actuator;
a piston for being driven in a rectilinear direction by the first actuator;
a housing that houses the piston and has an inlet port and an outlet port of the paste;
a cylinder arranged coaxially with the piston; and
a second actuator for producing a relative rotary motion between the piston and the cylinder,
the apparatus being constructed so that a pump chamber for communicating with the inlet port and the outlet port is formed between the piston and the housing, a pumping action is given to the pump chamber by a rotary motion or a rectilinear motion of the piston relative to the cylinder by driving the first actuator or the second actuator, and the first actuator is moved or extended and contracted by being externally supplied with an electric power electromagnetically in a noncontact manner so as to move the piston by the first actuator.

24. The display panel pattern forming apparatus as claimed in claim 21, wherein
in place of the thread groove type dispenser, the dispenser comprises:
a shaft;
a housing that houses the shaft and has an inlet port and an outlet port of the paste, the ports making a pump chamber formed between the housing and the shaft communicate with outside;
a unit for relatively revolving the shaft to the housing;
an axial drive unit for giving an axial relative displacement between the shaft and the housing; and
a unit for pressure-feeding the paste, which has flowed into the pump chamber, to the outlet port side,
the apparatus being constructed so that a gap between the shaft and the housing is changed by the axial drive unit in order to increase and decrease a fluid resistance of the paste between the pump chamber and the outlet port.

25. The display panel pattern forming apparatus as claimed in claim 21, wherein
the dispenser comprises:
a piston;
a housing that houses the piston and has an inlet port and an outlet port of the paste;
a first actuator that relatively moves the piston to the housing;
a cylinder having a space that accommodates at least a part of the piston and penetrates in an axial direction; and
a second actuator that relatively moves the cylinder to the housing,
the paste being supplied externally from the inlet port into a pump chamber formed of the piston, the cylinder, and the housing and discharged from the outlet port.

26. A display panel pattern forming apparatus, wherein
the dispenser comprises:
a piston accommodated in a cylinder;
an actuator that gives a relative motion to the cylinder and the piston in order to increase and decrease an internal space formed of the cylinder and the piston;
a housing that houses the cylinder or is integrated with the cylinder and has an inlet port and an outlet port of the paste; and
a fluid transport chamber formed in the housing,
the apparatus being constructed so that the paste, which has flowed into the fluid transport chamber from the inlet port, flows out via a passage connected to the internal space to the outlet port.

27. The display panel pattern forming apparatus as claimed in claim 26, which employs a dispenser in which a gap between the piston and its opposite surface is formed greater than a particle diameter of a particle included in the material to be discharged when the paste discharge is interrupted.

28. The display panel pattern forming apparatus as claimed in claim 27, wherein a minimum gap when the paste discharge is interrupted is not smaller than 8 mm in a passage extended from the inlet port to the discharge nozzle.

29. The display panel pattern forming apparatus as claimed in claim 21, wherein the control unit controls so that the paste is discharged when the dispenser is running relatively to an effective display area of the substrate that has the effective display area (60a, 700) in which the paste layer is formed and a non-effective display area (60b, 701A, 701B) which is located outside the effective display area and in which the paste layer is not formed, and the discharge of the paste is interrupted when the dispenser is running relatively to the non-effective display area.

30. The display panel pattern forming method as claimed in claim 1, wherein the paste is discharged when the dispenser is running relatively to an effective display area and a semi-effective display area of the substrate that has the effective display area (700) in which an electrode layer (705) is formed as the paste layer, the semi-effective display areas (701A, 701B) which are arranged adjacent to the effective display area and in which the continuous electrode layer and a discontinuous electrode layer (706) are formed, and a non-effective display area (704) which is provided virtually outside the effective display area and the semi-effective display area and in which no electrode layer is formed, and the discharge of the paste is interrupted when the dispenser is running relatively to the non-effective display area.

31. The display panel pattern forming method as claimed in claim 2, wherein the discharge of the paste is started in the semi-effective display area or the discharge in the effective display area is interrupted inside the semi-effective display area.

32. The display panel pattern forming method as claimed in claim 3, wherein the paste starts being discharged in a shape of a plurality of stripes in the semi-effective display area located adjacent to the effective display area by a dispenser that has a plurality of nozzles arranged at a regular pitch, and thereafter the discharge of the paste is performed via the effective display area, and the discharge of the paste in the shape of the plurality of stripes is interrupted in the semi-effective display area located adjacent to the other side of the effective display area.

33. The display panel pattern forming method as claimed in claim 2, wherein only electrode layers in shape of plurality of angled stripes having same angle of inclination are selected from the paste layer in the semi-effective display area by a dispenser that has a plurality of nozzles arranged at a regular pitch, and
the electrode layers in the shape of the plurality of stripes are formed by concurrently performing the discharge in the shape of the plurality of stripes in the semi-effective display area and/or the effective display area.

34. The display panel pattern forming method as claimed in claim 3, wherein, when the discharge of the paste is interrupted in the semi-effective display area, the discharge interruption is performed by utilizing generation of a negative pressure attendant on an increase in a gap of an internal passage of the dispenser.

35. A method for forming a paste layer of a certain pattern, comprising:
simultaneously with rotating a motor of a master pump to supply paste to a dispenser having a piston, moving said piston downward so as to initiate discharge of said paste from said dispenser; then
discharging said paste from said dispenser onto an effective display area of a substrate by passing said dispenser over said effective display area while rotating said motor and moving said piston downward; and then
moving said piston upward so as to stop discharge of said paste from said dispenser and prevent discharge of said paste from said dispenser while said dispenser is passing over a non-effective display area of said substrate, with said non-effective display area being located outwardly of said effective display area.

36. The method according to claim 35, further comprising:
after said dispenser has passed over said non-effective display area,
(i) simultaneously with rotating said motor of said master pump to supply said paste to said dispenser, moving said piston downward so as to initiate discharge of said paste from said dispenser; then
(ii) discharging said paste from said dispenser onto said effective display area by passing said dispenser over said effective display area while rotating said motor and moving said piston downward; and then
(iii) moving said piston upward so as to stop discharge of said paste from said dispenser,
thereby successively discharging said paste onto said effective display area.
